(19) United States
(12) Patent Application Publication
(10) Pub. No.: US 2015/0312348 A1
(43) Pub. Date: Oct. 29, 2015

(54) METHODS, APPARATUS, AND SYSTEMS FOR HOME INFORMATION MANAGEMENT

(71) Applicant: David Lustgarten, Caracas (VE)

(72) Inventor: David Lustgarten, Caracas (VE)

(21) Appl. No.: 14/692,274

(22) Filed: Apr. 21, 2015

Related U.S. Application Data
(60) Provisional application No. 61/983,772, filed on Apr. 24, 2014.

(51) Int. Cl. H04L 29/08; H04L 12/28; G06Q 30/02

(52) U.S. Cl. CPC H04L 67/12; H04L 67/1095; G06Q 30/0269; H04L 12/2827

(57) ABSTRACT

Methods and apparatus for home information management comprise receiving at an inventory manager, inventory information for a first user of multiple users supported by the inventory manager. The inventory information may correspond to one or more devices (e.g., household appliances) associated with the first user. One or more third-party services may be identified that are associated with the first user and at least a portion of the inventory information may be provided to the one or more third-party services. Services information may be received from the one or more third-party services in response to the at least a portion of the inventory information provided, and the services information may be provided for transmission to a device (e.g., wireless device) associated with the first user for the services information to be accessed by the first user. The services information may be associated with recipes, coupons, products, health, and fitness information.

### CLAIM OF PRIORITY

The present application for patent claims priority to U.S. Provisional Application No. 61/983,772, entitled “METHODS, APPARATUS, AND SYSTEMS FOR HOME INFORMATION MANAGEMENT,” filed on Apr. 24, 2014, which is assigned to the assignee hereof and is hereby expressly incorporated by reference herein.

### BACKGROUND

Aspects of the present disclosure relate generally to information management, and more particularly, to methods and apparatus for home information management.

The home is becoming the next frontier of advanced communications technology. Companies are now developing household appliances that can be controlled digitally, allowing homeowners to more efficiently make use of those appliances. Moreover, these digitally-controlled household appliances may provide large amounts of data about the users and their experiences. In fact, the right user experience is critical for consumer adoption of the so-called smart home information management systems that integrate one or more digitally-control household appliances and/or other digital devices. Overall, the user experience has to be simple to use and intuitive. There is a need to make use of the data being collected and generated by these smart home information management systems to improve the user experience.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, methods and apparatus for home information management comprise receiving at an inventory manager, inventory information (e.g., kitchen or appliance inventory information) for a first user of multiple users supported by the inventory manager. The inventory information may correspond to one or more devices (e.g., household appliances, household device) associated with the first user. One or more third-party services may be identified that are associated with the first user (e.g., subscription- or registration-based services) and at least a portion of the inventory information may be provided to the one or more third-party services. Services information may be received from the one or more third-party services in response to the at least a portion of the inventory information provided, and the services information may be provided for transmission to a device (e.g., wireless device) associated with the first user for the services information to be accessed by the first user. The services information may specify, for the first user, information about one or more products, one or more services, or both, in connection with the one or more third-party services. The services information may be associated with recipes, coupons, products, health, and fitness information, to name a few.

In accordance with another aspect, methods and apparatus for home information management comprise sending, by a mobile terminal, one or more requests to an inventory manager through at least one inventory application configured to execute on the mobile terminal, wherein each of the one or more requests are in response to services information received from one or more third-party services associated with a first user of the mobile terminal, wherein the services information specify, for the first user, information about one or more products, one or more services, or both, in connection with the one or more third-party services, and wherein the first user is one of multiple users supported by the inventory manager. One or both of a particular product and a particular service may be received from the inventory manager in response to the one or more requests. The services information may include one or more of recipes information, coupons information, product information, health information, and fitness information, which may be identified based at least in part on inventory information obtained by the inventory manager and associated with the first user.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1A is a diagram conceptually illustrating an example of a smart home information management system in accordance with the disclosure.

FIG. 1B is a diagram conceptually illustrating an example of a smart kitchen information management system in accordance with the disclosure.

FIG. 2 is a diagram conceptually illustrating an example of a scenario for use of a smart kitchen information management system in accordance with the disclosure.

FIG. 3A is a diagram conceptually illustrating database network used in connection with a smart home information management system in accordance with the disclosure.

FIG. 3B is a diagram conceptually illustrating a database network used in connection with a smart kitchen information management system in accordance with the disclosure.

FIG. 4A is a block diagram conceptually illustrating an assets and services information manager in accordance with the disclosure.

FIG. 4B is a block diagram conceptually illustrating a kitchen information manager in accordance with the disclosure.

FIG. 5 is a diagram conceptually illustrating a database organization in accordance with the disclosure.

FIG. 6A is a block diagram conceptually illustrating an assets and services information application in accordance with the disclosure.

FIG. 6B is a block diagram conceptually illustrating a kitchen information application in accordance with the disclosure.

FIG. 7 is a block diagram conceptually illustrating a set of sub-applications for a kitchen information application in accordance with the disclosure.

FIG. 8 is a flow diagram conceptually illustrating a method for home information management in accordance with the disclosure.

FIG. 9 is a flow diagram conceptually illustrating a method for kitchen information management in accordance with the disclosure.

FIG. 10 is a flow diagram conceptually illustrating a method for interacting with an inventory manager in accordance with the disclosure.

FIG. 11 is a block diagram conceptually illustrating an apparatus for home and/or kitchen information management in accordance with the disclosure.

FIG. 12 is a flow diagram conceptually illustrating a method for generating recommendations in an inventory manager in accordance with the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various aspects of the present disclosure refer to smart home information management systems having one or more digitally controlled and/or accessible devices (e.g., household appliances, digital thermostats, etc.). In some aspects, there may be various services that may be provided (e.g., third-party services) to a household user through a smart home information management system. These services may be free or fee-based, with some including premium fees to receive special services, offers, promotions, or the like. A smart home information management system such as the one described herein may automatically collect and/or store information associated with any one of the devices and/or appliances associated with the system. The information may include information about content (e.g., products, goods, assets, resources, articles, items) within a device or appliance as well as information about the operation of the device or appliance. In some instances, a user of the smart home information management system may interface with the system through a communications device (e.g., mobile device or terminal, laptop, tablet). The communications device may support, or may be configured to support, one or more applications that may be used to receive, process, and/or otherwise handle information collected by the smart home information management system and/or information provided by the various services. In some instances, the communications device may support, or may be configured to support, one or more applications that may enable the smart home information management system to access, collect, or otherwise obtain, through the communications device, inventory information associated with any one of the devices and/or appliances associated with the user of the smart home information management system. The communications device may include a graphical user interface (GUI) or some other interface or interface device to access information (e.g., inventory information) collected by the smart home information management system and/or to access information (e.g., services information) provided to the smart home information management system by the various services associated with the user of the smart home information management system. The smart home information management system may support multiple users in the same or different homes. For example, the smart home information management system may support one or more users associated with a first home or first building, while it may also support one or more users associated with a second home or second building. The smart home information management system may provide certain features and/or services that are common to users associated with the first home and certain features and/or services that are common to users associated with the second home. For example, the smart home information management system may offer a first group of users associated with a first home a first set of common features and/or services, and a second group of users associated with a second home a second set of common features and/or services different from the first set.

The smart home information management system described herein may be configured to support social and network collaboration in connection with one or more of the services provided to a user of the smart home information management system. There may be more than one user associated with the smart home information management system and each user may have a different configuration, for example, a different set of services and/or system features to which the user has access. As noted above, users associated with a same home may have a set of common system features and/or services.

As noted above, the smart home information management system described herein may collect information provided by one or more household appliances or devices (e.g., smart appliances). The smart home information management system may be configured to store, process, classify, organize, distribute, and/or otherwise handle information (e.g., inventory information) from each digitally-accessed household appliance and/or household device (e.g., thermostat, lighting controller, humidifier) in communication with the smart home information management system. The smart home information management system may also be configured to store, process, classify, organize, distribute, and/or otherwise handle information (e.g., services information) from each service associated with one or more users of the smart home information management system. Accordingly, the smart home information management system may be configured to perform various types of analysis (e.g., may perform artificial intelligence (AI)-based algorithms or processes) from which it can identify and/or learn preferences, patterns, routines, behavior, and the like for one or more users, one or more household appliances/devices, and/or one or more services. The analysis may be based on collecting the information and processing that information at least based on the algorithms and processes described herein. The smart home information management system may also be configured to make recommendations and suggestions to the users regarding various aspects of home-related activities including shopping, cooking, cleaning, and the like, as well as home-related products and services. These recommendation and suggestions can be provided as documents, text messages, e-mail messages, audio messages, or otherwise, which are received and announced (e.g., displayed, reproduced) in the user's communications device. For example, the smart home information management system may perform data mining or other similar data searching processes to identify preferences, patterns, routines, and/or to make recommendations and suggestions to users. In this regard, the smart home information management system may mine, extract, or obtain information from the inventory information, from the services information, and/or from historical information captured and stored as part of one or more of the functions performed by the smart home information management system.

The smart home information management system may also be configured to include and/or have access to multiple databases and/or storage devices (e.g., network storage devices). The number and type of databases may be based on the services supported or accessed by users of the smart home information management system. For example, the smart home information management system may include and/or may provide access to a products database associated with different types of products (e.g., food, cleaning materials, clothing, toiletries, linens, etc.). In a related example, the smart home information management system may enable a data application programming interface (API) platform to be used, such as Semantics3. In another example, the smart home information management system may include and/or may provide access to a users database that has information (e.g., configuration, preferences, services, etc.) related to each user of the smart home information management system. The users database may indicate whether a user is part of a user group having a common configuration, common preferences, common services, and/or common features. In yet another example, the smart home information management system may include and/or may provide access to a recipes database associated with different types of recipes (e.g., ethnic recipes, health recipes, low-calorie recipes, gluten-free recipes, nut-free recipes, etc.). In a related example, the smart home information management system may enable a recipes API platform to be used such as yummly.

In yet another example, the smart home information management system may include and/or may provide access to an inventory database associated with different types of household inventory (e.g., kitchen inventory, bathroom inventory, bedroom inventory, pantry inventory, garage inventory, basement inventory). In yet one more example, the smart home information management system may include and/or may provide access to a services database associated with different types of services available through the smart home information management system, including free services, fee-based services, temporary services, and the like. The smart home information management system may provide coordination and/or communication among the various databases to which it provides access.

The smart home information management system may also be configured to autonomously search (e.g., crawl) for information in the internet or other networks, where the information being sought corresponds or is related to services and/or inventory information. For example, the smart home information management system through one or more services (e.g., through applications associated with the services) may identify sales, coupons, deals, offers, or the like related to items currently part of the household inventory (e.g., kitchen inventory, garage inventory). Generally, the smart home information management system may provide an information platform from which various services can be provided to more efficiently perform household functions by leveraging the ability to control and obtain information about the home from intelligent or smart appliances and devices. In this regard, the smart home information management system may provide a platform that supports business-to-business (B2B) and business-to-consumer (B2C) services.

While there is a push to further develop household appliances and/or household devices that can self-regulate or that can optimize their operations, the smart home information management system described herein is configured to leverage the capabilities of these appliances and devices to provide new services that use of the information available (e.g., behavioral information, assets/inventory information) to make household functions performed by the user of the smart home information management system much easier to do and improve the quality of life of the user.

The smart home information management system described herein is configured to provide a simple and intuitive user experience that would make the adoption of smart appliances and/or devices much easier for the user. These smart appliances and devices can provide large amounts of data about their behavior and the user's behavior in connection with the appliance/device. This data can be collected and used by the smart home information management system to provide services suitable to the behavior of the appliance/device and/or user. For example, a smart dishwasher may now provide information that the smart home information management system can use to identify patterns of user behavior and operation of the appliance. The smart home information management system may use these identified patterns to provide services (e.g., maintenance, coupons for dishwasher soap) and/or offer products to the user for the smart dishwasher. Similarly with smart ovens (e.g., coupons for oven cleaner, glass cleaner), smart refrigerators (e.g., coupons for milk, orange juice, eggs), and smart pantries (e.g., coupons for cookies, paper towels).

The smart home information management system described herein may be configured to control large appliances digitally so that homeowners can set them to run at the time of day when energy prices are at their lowest. Heating, ventilation, and air conditioning (HVAC) systems like forced air and zoned heating systems may also be able to work together within a smart home information management system to be energy efficient while maintaining a desired temperature.

The smart home information management system described herein may enable a user to access the system through an application in a communications device such as a smart phone or tablet, for example. In some instances, the user may tell the system what is in the refrigerator by a simple drag-and-drop of items on the application. In other instances, the refrigerator may be connected (e.g., wirelessly or otherwise) with the system through a local access point or small cell and may provide food inventory information directly to the system without user involvement. Whether through user input or direct upload from the refrigerator, the application may list the food items in the refrigerator and the application may provide possible dinner options by searching a third-party recipe service (e.g., Epicurious) to find a recipe using as ingredients the food items listed in the application. The smart home information management system may be configured to set or collect a fee to coordinate the collection and sharing of inventory information and the service or services that rely of the inventory information. The fee may be received by the smart home information management system when, for example, the product or service (e.g., recipe) is delivered to the user or when the user makes use of the product or service.

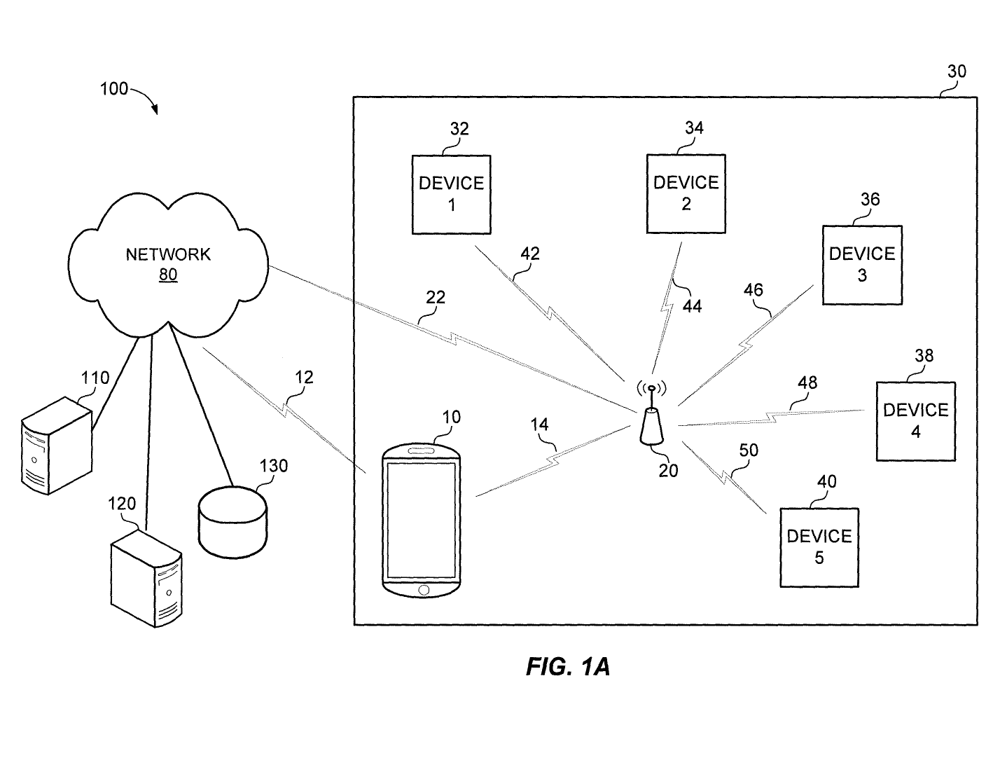

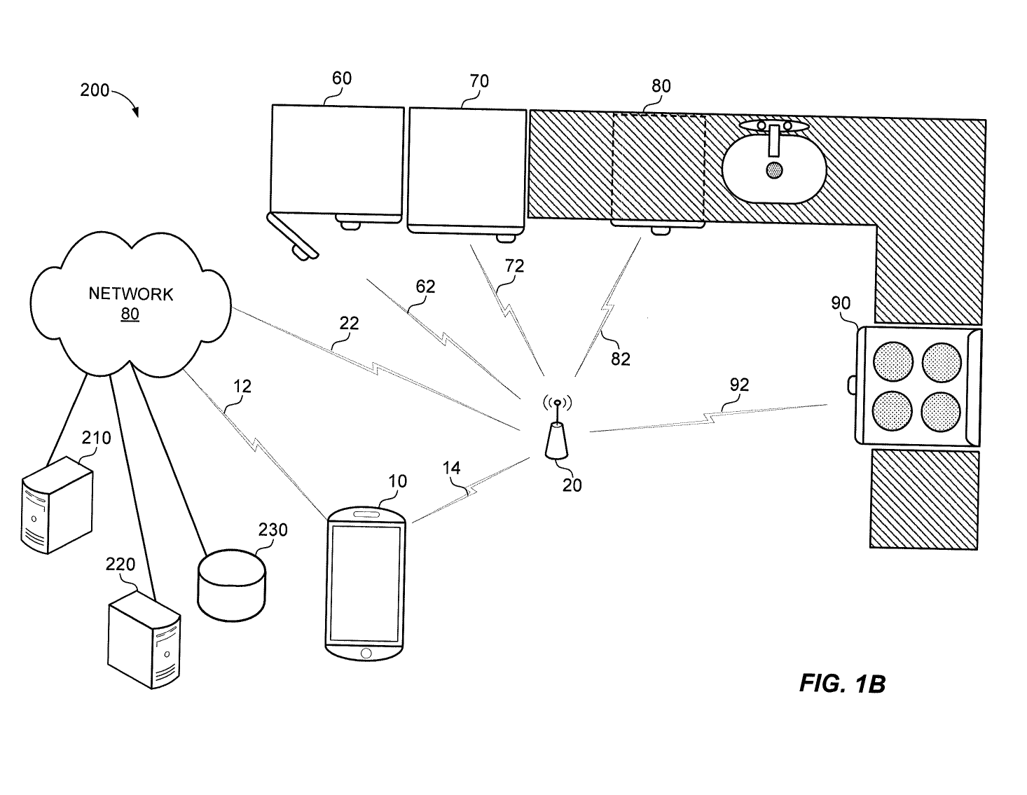

In another example, the smart home information management system may be configured to identify historical inventory behavior from information collected over an extended period of time. Historical inventory behavior information may refer to information collected over a specified period of time and related to changes in the inventory of a certain set of items, products, assets, resources, and/or goods. In one example, the historical inventory behavior information may be used to identify when certain food items are running low and provide that information to a third-party coupons service to provide coupons or some other discounts or sales opportunities for the user to replenish the food items. An item may be running low when the current amount of that particular item in a pantry, in a refrigerator, and/or other storage facilities, is less than an average or a mean determined for that particular item over the specified period of time. Coupons or offers provided by a third-party services or otherwise may be electronic documents received in a device (e.g., wireless device 10 in FIG. 1A) that can be scanned from a display in the device to be redeemed or can be printed to be redeemed. Again, the smart home information management system may be configured to set or collect a fee to coordinate the collection and sharing of inventory information and the service or services that rely of the inventory information.

In another example, the smart home information management system may generally be configured to identify changes in inventory (e.g., household assets or items) and identify one or more services associated with the user for which the change in inventory is relevant. The system may then coordinate the sharing of the inventory information with the services to obtain products, offers, coupons, recipes, discounts, advertisement, other services, or the like that make household functions easier to perform for the user. For example, the system can deliver applications to the user (e.g., consumer) that greatly improve the user's quality of life, by optimizing the user's budget, time, and health. The smart home information management system can therefore translate the data or information collected into services, applications, and solutions that help the user carry out their daily chores. That is, the smart home information management system can provide a platform from which individuals, small and medium businesses can provide services or related offerings that target the user of the system as potential customers. This can be done while protecting the user's privacy. The smart home information management system can therefore enable a community of individuals and businesses gathering together in a platform that provides the structure to transform the way users behave and manage their health and nutrition, make purchases around the house, and otherwise improve their use of time. Therefore, smart home information management system is configured to deliver a vast arrange of options to help a user save time, money, gain knowledge, and improve household-related decision making processes.

In yet another example, the smart home information management system may include the use of one or more applications in, for example, a wireless device in communication with an assets and services information manager and/or a network entity (e.g., a small cell). The applications may be configured to allow a user to manage an inventory of food and/or other household stock. The applications may configured to assist the user in household chores, including aspects related to dynamic management of inventory of food in a pantry, a refrigerator, and/or other storage facilities or appliances. The dynamic management may involve keeping an up-to-date list of food and/or other items. The applications may provide access to various links or websites from which the user can obtain cooking and food information.

In yet another example, the smart home information management system may be configured to assist the user by generating a grocery list, find or identify recipes for certain categories of foods, find or identify appropriate cooking tools for purchase, find or identify chefs or cooks that provide services for various types of events, help coordinate catering for meetings, special events, or theme parties, find or identify the calorie count and energy content of different recipes and foods.

In yet another example, the smart home information management system may be configured to support a wireless device or some other device that includes a barcode reader, a food scale, a full scale, and a radio frequency identification (RFID) sensor. The smart home information management system may also be configured to support tablets and/or smart appliances or devices. The various appliances or devices supported by the smart home information management system may communicate with the system through, for example, a Wi-Fi, Bluetooth, near field communication (NFC), or some other type of wireless communications protocol.

Accordingly, in some aspects, the present methods and apparatus may provide an efficient and effective solution, as compared to current solutions, to home information management. In an aspect, the present apparatus and methods include receiving at an inventory manager, inventory information (e.g., kitchen or appliance inventory information) for a first user of multiple users supported by the inventory manager. The inventory information may correspond to one or more devices (e.g., household appliances, household device) associated with the first user. One or more third-party services may be identified that are associated with the first user (e.g., subscription- or registration-based services) and at least a portion of the inventory information may be provided to the one or more third-party services. Services information may be received from the one or more third-party services in response to the at least a portion of the inventory information provided, and the services information may be provided for transmission to a device (e.g., wireless device) associated with the first user for the services information to be accessed by the first user. The services information may be associated with recipes, coupons, products, health, and fitness information, to name a few.

As described herein, the terms product, good, asset, resource, article, and item may be used interchangeably to refer to an object related to consumption or use by a user. These terms may be used in connection with merchandise for a user in a smart home information management system.

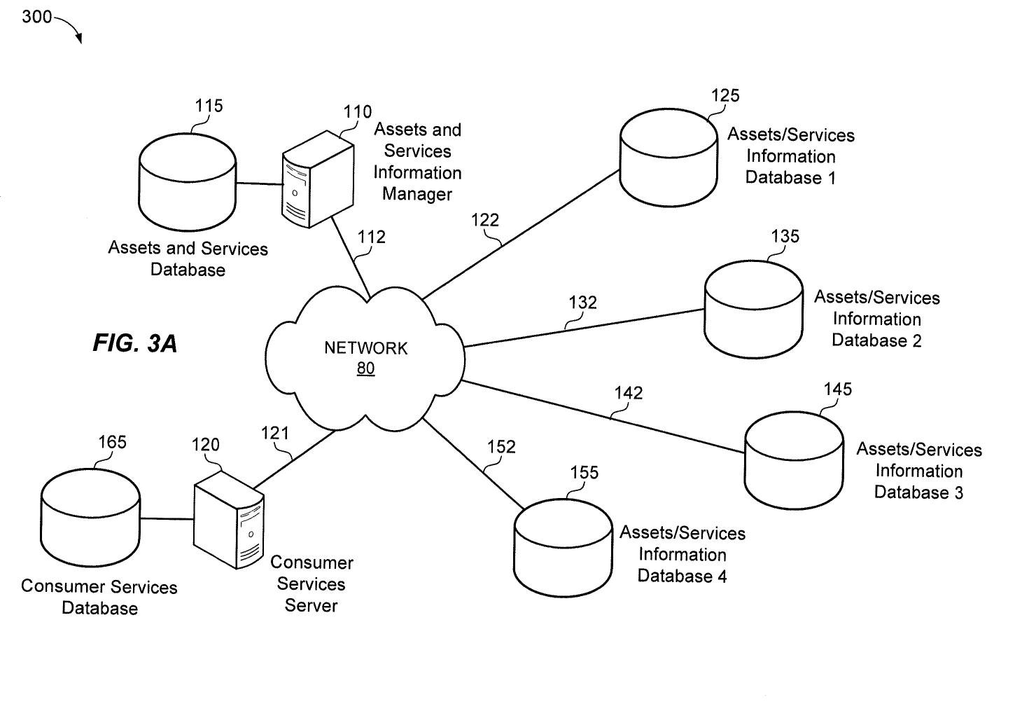

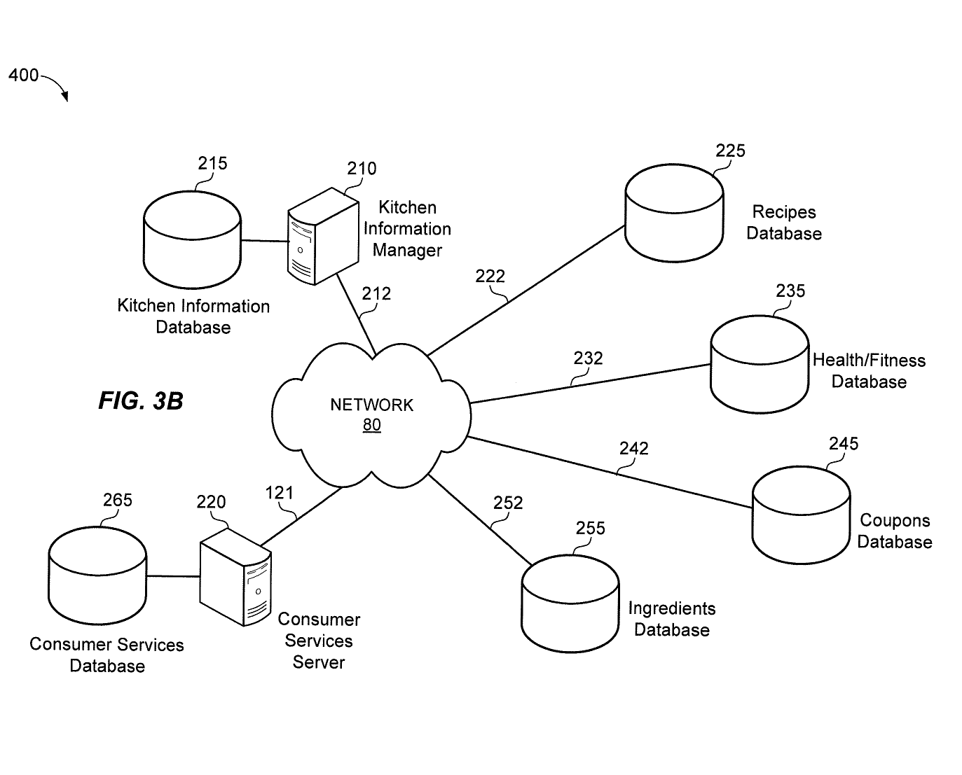

FIG. 1A shows a diagram 100 conceptually illustrating an example of a smart home information management system in accordance with the disclosure. The system associated with FIG. 1A can include an access point (AP) 20 that is configured to communicate with one or more devices (e.g., household devices, household appliances), with one or more wireless devices such as a wireless device 10, and with one or more networks such as a network 80. The AP 20 can be configured to collect data from devices 32, 34, 36, 38, and 40 in a room 30 by receiving the data wirelessly from those devices. For example, devices 32, 34, 36, 38, and 40 may communicate wirelessly with AP 20 through wireless links 42, 44, 46, 48, and 50, respectively. The devices 32, 34, 36, 38, and 40 are referred to in FIG. 1A as device 1, device 2, device 3, device 4, and device 5, respectively. The AP 20 may be a Wi-Fi AP or may support some other wireless communications protocol suitable for a smart home information management system. The room 30 can be any room in a house or building, or can represent portions of different rooms that can be logically grouped together and that contain the devices 32, 34, 36, 38, and 40. The data collected by the AP 20 can include inventory information (e.g., items stored), behavior or performance information (e.g., usage rates/times, power consumption), service or maintenance information (e.g., notification of malfunctioning part), and other data identifying aspects of the operation of the devices. In general, the data collected by the AP 20 may be referred to inventory data even when it includes behavior/performance information and/or service/maintenance information. Data collected by the AP 20 may be communicated through the network 80 using a wireless link 22 to an inventory manager such as an assets and services information manager 110 (see description below for FIG. 3A) that may be part of the smart home information management system. The network 80 in FIG. 1A may also be in communication with a consumer services center 120 and/or with one or more databases 130 (see description below for FIG. 3A), which may be part of the smart home information management system.

The wireless device 10 may be referred to as a mobile device, a wireless terminal or station, a user equipment, a tablet, a laptop, or some other term that represents a communications device configured for wireless communications and having sufficient computational resources to run or execute applications for a user to interact or interface with the smart home information management system. The wireless device 10 may communicate with the AP 20 through wireless link 14. In some instances, the wireless device 10 may be configured to communicate with the AP 20 through a wired link (e.g., via an add-on or docking station). Although not shown in FIG. 1A, the wireless device 10 may also be configured to wirelessly collect data from the devices 32, 34, 36, 38, and 40. In some instances, the wireless device 10 may run or execute various applications that allow a user of the smart home information management system to upload inventory information into the system. For example, a user may look inside device 32 and may list the items stored in device 32 using an application on wireless device 10. The list of items (e.g., food items, toiletries, tools, etc.) may then be uploaded to the smart home information management system through the network 80. In some instances, the wireless device 10 may send the data collected (e.g., list of items) to the smart home information management system via the AP 20.

One or more of the devices 32, 34, 36, 38, and 40 may be configured to identify assets or items stored within the device. Moreover, one or more of the devices 32, 34, 36, 38, and 40 may be configured to self-diagnose and provide the results of such operation to the smart home information management system via the AP 20 and/or the wireless device 10. For example, device 32 can self-diagnose and can provide behavior/performance information and/or service/maintenance information to the AP 20 for the smart home information management system to use such information in connection with services and/or products to be provided to a user of the smart home information management system. In some instances, the wireless device 10 may be configured to scan or read such behavior/performance information and/or service/maintenance information from a device and send the data collected to an inventory manager that may be part of the smart home information management system via the AP 20 or directly through the network 80 using wireless link 12.

FIG. 1B is a diagram 200 conceptually illustrating an example of a smart kitchen information management system in accordance with the disclosure. The smart kitchen information management system may be similar to a smart home information management system but may include certain features or aspects that are suitable for managing information associated with kitchen items (e.g., food items, cooking items, cleaning items) and related chores (e.g., cooking, cleaning).

The system associated with FIG. 1B can include the AP 20 described above, which is configured to communicate with one or more kitchen devices (e.g., kitchen appliances), with one or more wireless devices such as the wireless device 10, and with one or more networks such as the network 80. The AP 20 can be configured to collect data from kitchen device 60 (e.g., pantry), kitchen device 70 (e.g., refrigerator), kitchen device 80 (e.g., dishwasher), and kitchen device 90 (e.g., stove/oven) by receiving the data wirelessly from those devices. For example, kitchen devices 60, 70 80, and 90 may communicate wirelessly with AP 20 through wireless links 62, 72, 82, and 92, respectively. The data collected by the AP 20 can include inventory information (e.g., food items stored in the pantry and/o refrigerator), behavior or performance information (e.g., usage rates/times, power consumption), service or maintenance information (e.g., notification of malfunctioning part), and other data identifying aspects of the operation of the devices. In general, the data collected by the AP 20 may be referred to inventory data even when it includes behavior/performance information and/or service/maintenance information. Data collected by the AP 20 may be communicated through the network 80 using a wireless link 22 to an inventory manager such as a kitchen information manager 210 (see description below for FIG. 3B) that may be part of the smart kitchen information management system. The network 80 in FIG. 1B may also be in communication with a consumer services center 220 and/or with one or more databases 230 (see description below for FIG. 3B), which may be part of the smart kitchen information management system.

Although not shown in FIG. 1B, the wireless device 10 may also be configured to wirelessly collect data from kitchen devices 60, 70 80, and 90. In some instances, the wireless device 10 may run or execute various applications that allow a user of the smart kitchen information management system to upload inventory information into the system. For example, a user may look inside the pantry (kitchen device 60) and may list the items stored in the pantry using an application on wireless device 10. The list of items (e.g., food items, utensils, cleaning materials) may then be uploaded to the smart kitchen information management system through the network 80. In some instances, the wireless device 10 may send the data collected (e.g., list of items) to the smart kitchen information management system via the AP 20.

One or more of the kitchen devices 60, 70, 80, and 90 may be configured to identify assets or items stored within the device. Moreover, one or more of the kitchen devices 60, 70, 80, and 90 may be configured to self-diagnose and provide the results of such operation to the smart kitchen information management system via the AP 20 and/or the wireless device 10. For example, the dishwasher (kitchen device 80) or the stove/oven (kitchen device 90) can self-diagnose and can provide behavior/performance information and/or service/maintenance information to the AP 20 for the smart kitchen information management system to use such information in connection with services and/or products to be provided to a user of the smart kitchen information management system. In some instances, the wireless device 10 may be configured to scan or read such behavior/performance information and/or service/maintenance information from a device and send the data collected to an inventory manager that may be part of the smart kitchen information management system via the AP 20 or directly through the network 80 using wireless link 12.

While the examples shown in FIGS. 1A and 1B relate to information management of single rooms, the disclosure is not so limited. For example, a smart home (or kitchen) information management system may support the concurrent management of multiple rooms (e.g., kitchen, bathroom, garage, basement) in a home or building. Moreover, each home or building may have associated different users. In such instances, the smart home (or kitchen) information management system may be configured to support different sets of features (e.g., services such as third-party services) for each user. In addition, the smart home (or kitchen) information management system may support management of multiple households/buildings, where each of them may have multiple rooms to manage, and where there may be multiple users associated with a room or household/building. In this regard, the smart home (or kitchen) information management system may collect data from multiple sources and may analyze the data collected to identify or obtain best services and/or offers to users of the system.

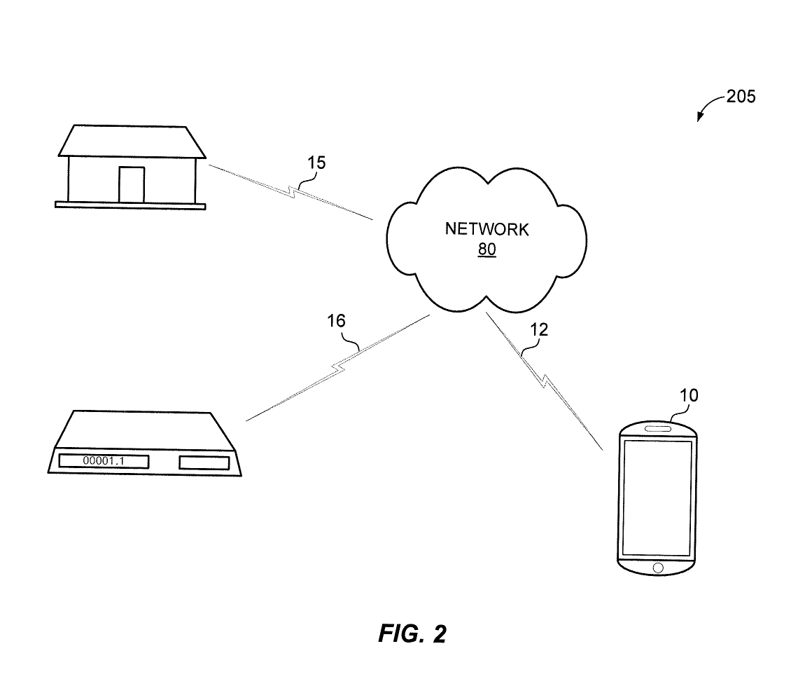

FIG. 2 is a diagram 205 conceptually illustrating an example of a scenario for use of a smart kitchen information management system such as the one described above in connection with FIG. 1B. In this scenario, there may be different ways in which the appropriate information may be captured or collected by the system. One approach may be to have the user manually provide the inventory information to the system via wireless device 10 through wireless link 12. Another approach may be to have the information provided directly to the system via a wireless link 18 by a sales/distribution entity 17 where the food item(s) or article(s) were purchased. The sales/distribution entity 17 may be a supermarket, a convenience store, a formal or informal market, an on-line store, or a specialized store (e.g., kosher, organic, fruit, butcher). Yet another approach may be to have a device 18 (e.g., digital scale), at home or elsewhere, that is configured to read information about the food items to provide such information to the system via wireless link 16. In some instances, two or more of these approaches may be used together to collect and/or provide an accurate representation of inventory information. Moreover, there may be instances in which the wireless device 10, the sales/distribution entity 17, and/or the device 18 can be in communication with the network 80 via a wired link or a combination of wired and wireless links. The kitchen information management system may be able to identify duplicate entries when more than one approach is used to keep inventory records accurate.

Based on these approaches, the information or data associated with purchased items or articles (e.g., food items) may be entered into the system to have update inventory information. In the manual approach, after the user completes his/her purchases and reaches his/her destination (e.g., home), the user may open or execute an application in the wireless device 10 in which the user may input each of the articles purchased. The user may further input the number of each article purchased as well as the weight, the size, and other like information.

In the manual approach, the user may also use the camera in the wireless device 10 to read the bar code and find the corresponding article in a database associated with the kitchen information management system (see e.g., FIG. 1B and FIG. 3B). In some cases, to make matters operate more easily and rapidly, the bar code information of multiple articles may be batched, processed, and compared to information in the database to obtain the corresponding articles. The user, by way of the wireless device 10, may then validate the articles resulting from the batch process to ensure that they are in fact the articles purchased by the user. When an article is not part of the database, the user may provide to the system relevant information about the purchased article, with the system being configured to verify the information provided, store the information in the database, and update any related information currently stored in the database.

The user may further provide to the system information about the price paid for the purchased article, as well as discounts or offers (e.g., store discounts) that may have been part of the purchase price. In one aspect, the application in the wireless device 10 may ask the user to provide the purchase price for each article entered, with the user having the option to provide the purchase price or not. The system may be configured to handle the purchase price information to provide special offers or discounts to the user, including providing such offers and discounts in advertisement directed at the articles for which the purchase price was provided. For example, affiliated commercial entities (e.g., third-party service providers) may be provided, by the system, with pricing information for a particular article—without violating any privacy or confidentiality aspects of the user—and may use such information to generate advertisement directed at those users in the system that are known to purchase or use that article. These affiliated commercial entities may include the manufacturer of the article, wholesale or retail businesses, on-line sellers, or low-cost businesses such as warehouse bulk sale clubs (e.g., Costco).

In the approach in which article purchase information may be provided directly to the system by the sales/distribution entity 17, the following considerations may apply. First, many such entities have the capability to send receipts via e-mail or some other form of electronic distribution to reduce the need for paper and to allow the user to keep electronic records of their purchase. Entities with such capabilities can join or become members of the smart kitchen information management system so that the system can receive electronic copies of the receipts and have the information in the receipts be stored to update the user's inventory of purchased items automatically. The entities that join or become members may be provided by the system with behavioral information about the user so that they can then identify and provide special offers or discounts to users based on their purchasing behavior. Manufacturers that are also affiliated with the system (e.g., join or become members), can have access to the behavioral information to provide offers to the users of alternative or substitute articles that may be healthier or more economic.

In the approach in which the device 18 reads information about the food items to provide such information to the system via wireless link 16, the following considerations may apply. The device 18 may be similar to devices used in supermarkets for scanning or reading bar codes, comparing the scanned information with a database, and provides a matching food item in response to the comparison. The device 18 may also be configured to weigh those food items without bar codes (e.g., perishable foods such as fruits, vegetables) so that information about those items can also be entered into the system. Once a user makes it home, he or she can use the device 18 to entered information about some or all of the purchased food items so that the inventory of items for that user is updated and current. The device 18 may have a simple interface to enable easy (e.g., single button) entry and easy (e.g., single button) removal of items from inventory once the item is scanned, in addition to a simple interface for weighing the appropriate items.

The smart kitchen information management system described in connection with FIG. 1B and FIG. 3B may be configured to enable input of data or information about articles or items consumed or to be consumed. For example, the kitchen information manager 210 and/or the kitchen information database 220 may be configured to receive, process, and analyze inventory information and related data associated with purchased and/or consumed articles. First, the process of inputting or registering the consumption or usage of is relatively fast (e.g., only a few seconds) and is part of the behavior of consumption or usage of the user. This is achieved by making the registration process part of the consumption flow of the user. For example, an application running or executing on wireless device 10 may easily allow the user to continuously update consumption of articles (e.g., food items) during the day (e.g., while the user cooks). As the user registers these changes in inventory through consumption with the system, the system can then be configured to analyze this information and provide the user with useful tips or other information.

In one example, if the user purchases a 12-pack of soda (e.g., Diet Coke®), the 12-pack is consumed at home in seven (7) days, and such behavior is identified to occur regularly, the system may suggest to the user, through discount or wholesale stores, buying larger quantities of soda at a lower cost and showing or displaying in the wireless device 10 how this approach may save the user money. The system may also offer or suggest services that may replenish the inventory of soda at certain times, and even have the capability of programming times at which certain articles or items need to be reordered or replenished. The system may also notify the user (e.g., audio, text, or other type of message) that a particular item needs to be purchased because the user is running out. This may be identified by comparing a current amount, volume, or quantity of a particular item with an average of that item over time or with a threshold programmed by the user, that is, a level of the item that the user prefers not to have less than in inventory. Moreover, the system may provide coupons, offers, or discounts for that item. Sales/distribution/delivery entities may provide or offer, through the system, to deliver the particular item to the user's residence. The system may be further configured to suggest, based on a purchasing pattern provided by the user, what is the optimal amount/volume/quantity of the item to purchase, where is best to purchase the item, and how much can the user save if the item is purchased in that way. Manufacturers may offer, through the system, similar or substitute items based on targeted advertisement to users of the item. For example, if a user consumes sugar, a manufacturer may offer a sugar substitute and may offer related discounts or coupons to purchase the sugar substitute.

In another example, a user purchases ten (10) apples and consumes six (6) apples a week. The system may keep track of a predetermined expiration date for certain types of perishable items. In this case, the system may determine that several of the apples are not being consumed before the expiration date and may suggest to the user changes in the user's purchase behavior to optimize the use and condition of perishable items.

Another aspect related to managing inventory information by the smart kitchen information management system is that the user may determine to update the inventory of kitchen-related items every few days and the system may be programmed to remind the user when to update the kitchen inventory. While this approach may not provide an up-to-the-minute tracking of inventory information, it allows the user to set up an operation that meets the user's preferred behavior.

In yet another aspect related to managing inventory information by the smart kitchen information management system includes products and/or services that may be offered to the user of the system. For example, the user may receive offers, discounts, or coupons for certain products, as well as suggestions regarding substitute or alternative products. The system may offer suggestions that are determined to reduce purchasing time and/or save the user money. In this regard, the system may identify a purchasing pattern that enables the user to buy less frequently and at lower cost. The system may also identify, and make accessible to the user, recipes that may be searchable based on existing items in inventory. The system may provide suggestions to make healthier purchases (e.g., by substituting certain items with healthier ones). The system may be further configured to keep track of a user's nutritional information and to analyze this information to provide recommendations or suggestions to improve nutritional intake. Through the system, services such as on-line weight management and monitoring may be offered that obtain the user's nutritional information from the system to assist in the managing and monitoring of the user's weight. Devices connected to the system, such as digital scales, can be used by nutrition and/or weight management and monitoring services to assist users with adjusting and tracking their diets. The system may further offer users recipes and other services related to special events, and may identify items missing or in low supply in inventory that need to be purchased for the special event. In addition, the system may enable catering services to be offered to users. Moreover, the system may identify changes in certain recipes based on the caloric content of different items in the recipe. For example, the system may determine that by replacing one item in a recipe with a substitute the amount of calories is reduced by a certain percentage. The system may offer multiple substitute options in a recipe and allow the user to identify the preferred recipe items that will provide a reasonable balance between caloric content and taste.

FIG. 3A and FIG. 3B below provide additional details regarding examples of a smart home information management system and a smart kitchen information management system, respectively.

FIG. 3A is a diagram 300 that conceptually illustrating database network used in connection with a smart home information management system in accordance with the disclosure. The database network may be associated with the smart home information management system described in connection with FIG. 1A. Diagram 300 shows the network 80 (FIGS. 1A and 1B) providing a communications platform for assets/services information databases 125, 135, 145, and 155 to communicate with an assets and services information manager 110 through links 122, 132, 142, and 152, respectively. The assets/services information databases 125, 135, 145, and 155 are referred to as assets/services information database 1, assets/services information database 2, assets/services information database 3, and assets/services information database 4, respectively, in FIG. 3A. The assets and services information manager 110 may be generally referred to as an inventory manager, information manager, or services manager, for example. The assets and services information manager 110 may be in communication with the AP 20 of FIG. 1A through network 80 using link 112. Moreover, the assets and services information manager 110 may be in communication with an assets and services database 115 configured to store, organize, and/or arrange data or information collected by the smart home information management system. In addition, the assets and services database 115 can include information about users of the smart home information management system such as the types of third-party services supported for each user (e.g., open services, subscription-based services, free services, fee-based services) and/or other information related to the users.

Diagram 300 also includes a consumer services server 120 in communication with the network 80 via link 121. The consumer services server 120 can provide third-party services to users of the smart home information management system based on requests for those services from the assets and services information manager 110. The consumer services server 120 may also be in communication with a consumer services database 165 that includes data or information that is used by the consumer services server 120 to provide services to users of the smart home information management system.

The assets and services information manager 110 may be configured to use different application programming interfaces (APIs) to communicate with the assets/services information databases 125, 135, 145, and 155 to provide and/or obtain information from the databases.

The assets and services information manager 110 may be configured to receive inventory information (e.g., inventory, performance, and/or maintenance information) for a first user of multiple users supported by the assets and services information manager 110, the inventory information corresponding to one or more devices (e.g., devices 32, 34, 36, 38, and 40 of FIG. 1A) associated with the first user; to identify one or more third-party services associated with the first user (e.g., from information stored in the assets and services database 115); to provide at least a portion of the inventory information to the one or more third-party services (e.g., consumer services server 120, databases 125, 135, 145, and 155); to receive services information from the one or more third-party services in response to the at least a portion of the inventory information provided; and to provide the services information for transmission to a device (e.g., wireless device 10) associated with the first user for the services information to be accessed by the first user.

FIG. 3B is a diagram 400 conceptually illustrating a database network used in connection with a smart kitchen information management system in accordance with the disclosure. The database network may be associated with the smart kitchen information management system described in connection with FIG. 1B. Diagram 400 shows the network 80 (FIGS. 1A and 1B) providing a communications platform for recipes database 225, health/fitness database 235, coupons database 245, and ingredients database 255 to communicate with a kitchen information manager 210 through links 222, 232, 242, and 252, respectively. The kitchen information manager 210 may be generally referred to as an inventory manager, information manager, kitchen manager, or services manager, for example. The kitchen information manager 210 may be in communication with the AP 20 of FIG. 1B through network 80 using link 212. Moreover, the kitchen information manager 210 may be in communication with a kitchen information database 215 configured to store, organize, and/or arrange data or information collected by the smart kitchen information management system. In addition, the kitchen information database 215 can include information about users of the smart kitchen information management system such as the types of third-party services supported for each user (e.g., open services, subscription-based services, free services, fee-based services) and/or other information related to the users.

Diagram 400 also includes a consumer services server 220 in communication with the network 80 via link 221. The consumer services server 220 can provide third-party services to users of the smart kitchen information management system based on requests for those services from the kitchen information manager 210. The consumer services server 220 may also be in communication with a consumer services database 265 that includes data or information that is used by the consumer services server 220 to provide services to users of the smart home information management system.

The kitchen information manager 210 may be configured to use different application programming interfaces (APIs) to communicate with the databases 125, 135, 145, and 155 to provide and/or obtain information from the databases.

The kitchen information manager 210 may be configured to receive kitchen inventory information (e.g., inventory, performance, and/or maintenance information) for a first user of multiple users supported by the kitchen information manager 210; to identify one or more third-party services associated with the first user (e.g., from information stored in the kitchen information database 215); to provide at least a portion of the information to the one or more third-party services (e.g., consumer services server 220, databases 225, 235, 245, and 255); to receive services information from the one or more third-party services in response to the at least a portion of the information provided; and to provide the services information for transmission to a device (e.g., wireless device 10) associated with the first user for the services information to be accessed by the first user.

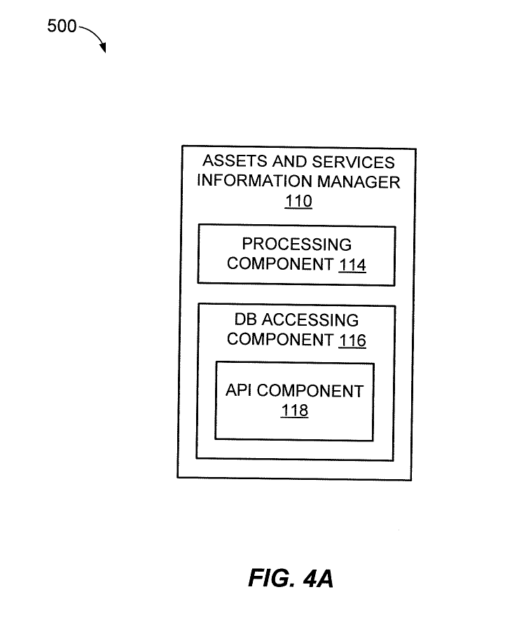

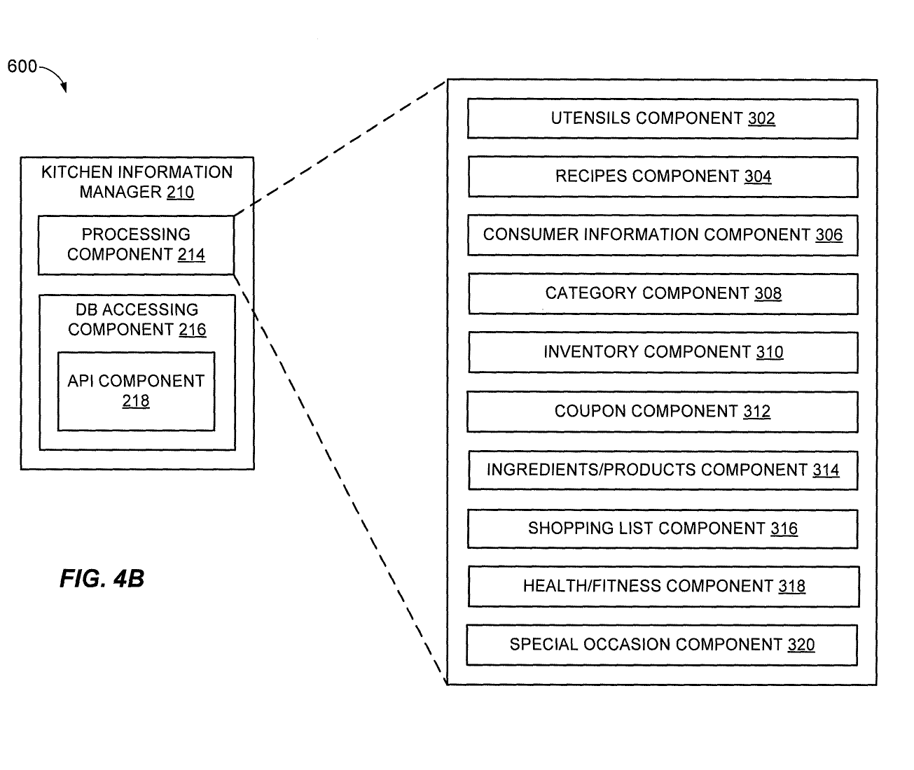

FIG. 4A is a block diagram 500 conceptually illustrating the assets and services information manager 110 (FIG. 3A) in accordance with the disclosure. The assets and services information manager 110 can include a processing component 114 and a database (DB) accessing component 116. The components 114 and 116 may be implemented in hardware, software (e.g., embedded software, run-time executable instructions, instructions stored in computer-readable media), or a combination of the two. The processing component 114 may be configured to perform processing operations on data received that is associated with a smart home information management system. Such data may include inventory information, services subscription information, and user preference information (e.g., preferences about services, offers, sales, discounts, products), for example. The processing component 114 may be configured to perform processing operations on services information received from, for example, the consumer services server 120 and/or the databases 125, 135, 145, and 155 of FIG. 3A. The DB accessing component 116 may include an API component 118 that may have one or more APIs for interfacing or interacting with external databases (e.g., databases 125, 135, 145, and 155 of FIG. 3A).

FIG. 4B is a block diagram 600 conceptually illustrating a kitchen information manager 210 (FIG. 3B) in accordance with the disclosure. The kitchen information manager 210 can include a processing component 214 and a DB accessing component 216. The components 214 and 216 may be implemented in hardware, software (e.g., embedded software, run-time executable instructions, instructions stored in computer-readable media), or a combination of the two. The processing component 214 may be configured to perform processing operations on data received that is associated with a smart kitchen information management system. Such data may include inventory information, services subscription information, and user preference information (e.g., preferences about services, offers, sales, discounts, products), for example. The processing component 214 may be configured to perform processing operations on services information received from, for example, the consumer services server 220 and/or the databases 225, 235, 245, and 255 of FIG. 3B. The DB accessing component 216 may include an API component 218 that may have one or more APIs for interfacing or interacting with external databases (e.g., databases 225, 235, 245, and 255 of FIG. 3B).

The processing component 214 may include one or more components to perform functions associated with managing kitchen information. For example, the processing component 214 may include a utensils component 302, a recipes component 304, a consumer information component 306, a category component 308, an inventory component 310, a coupon component 312, an ingredients/products component 314, a shopping list component 316, a health/fitness component 318, and a special component 320.

The utensils component 302 may be configured to process information to determine, identify, select, process, or otherwise handle aspects related to kitchen utensils or other kitchen-related tools.

The recipes component 304 may be configured to process information to determine, identify, select, process, or otherwise handle aspects related to food recipes or other food preparation or handling methods. The recipes component 304 may interact with, for example, the recipes database 225 of FIG. 2B.

The consumer information component 306 may be configured to process information to determine, identify, select, process, or otherwise handle aspects related to consumer services and/or user information (e.g., user preferences, services, subscriptions). The consumer information component 306 may interact with, for example, the consumer services server of FIG. 3B.

The category component 308 may be configured to process information to determine, identify, select, process, or otherwise handle aspects related to categorization of items, products, or services-related information. For example, categorization may involve identifying ethnic food types, foods for special events, and the like.

The inventory component 310 may be configured to process information to determine, identify, select, process, or otherwise handle aspects related to inventory information for one or more devices (e.g., kitchen appliances, smart kitchen devices, smart pantries).

The coupon component 312 may be configured to process information to determine, identify, select, process, or otherwise handle aspects related to coupons, offers, discounts, or the like. The coupon component 312 may interact with, for example, the coupons database 245 of FIG. 3B.

The ingredients/products component 314 may be configured to process information to determine, identify, select, process, or otherwise handle aspects related to ingredients, products, or the like. The ingredients/products component 314 may interact with, for example, the ingredients database 255 of FIG. 3B.

The shopping list component 316 may be configured to process information to determine, identify, select, process, or otherwise handle aspects related to preparing a shopping list based on information available to the smart kitchen information management system.

The health/fitness component 318 may be configured to process information to determine, identify, select, process, or otherwise handle aspects related to health and fitness information associated with food selection and/or preparation. The health/fitness component 318 may interact with, for example, the health/fitness database 235 of FIG. 3B.

The special occasion component 320 may be configured to process information to determine, identify, select, process, or otherwise handle aspects related to food selection and/or food preparation for specific events. For example, the special occasion component 320 may interact with an external service provider and/or database to generate an appropriate menu consistent with a specific event type (e.g., birthday party, family reunion).

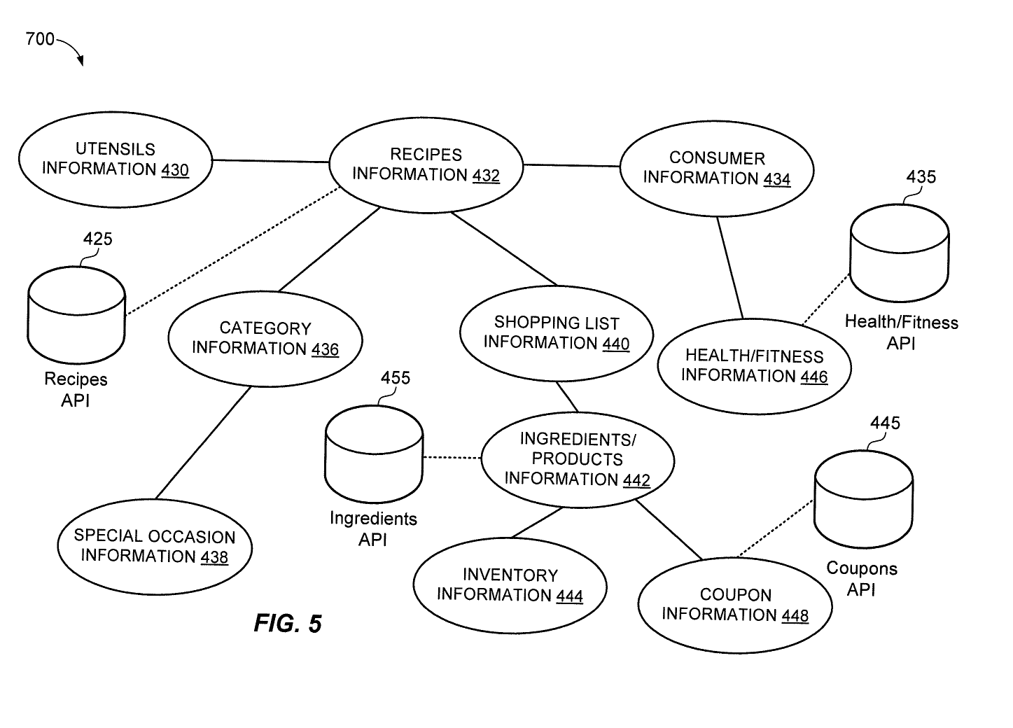

FIG. 5 is a diagram 700 conceptually illustrating a database organization in accordance with the disclosure. Diagram 700 shows an example of the relationship between different data types associated with a smart kitchen information management system such as the one described above with respect to FIGS. 1B, 3B, and 4B. For example, data may be organized as shown with recipes information 432 being associated with utensils information 430 and consumer information 434. Recipes information 432 may also be associated with category information 436, which in turn is associated with special occasion information 438. Recipes information 432 may also be associated with shopping list information 440, which in turn is associated with ingredients/products information 442, which in turn is associated with inventory information 444 and coupon information 448. Consumer information 434 may be associated with health/fitness information 446.

In addition to the data relationships, FIG. 5 also shows connections between certain information and external databases through APIs. For example, recipes information 432 may be communicated with an external database (e.g., recipes database 225 of FIG. 3B) through recipes API 425. In another example, ingredients/products information 442 may be communicated with an external database (e.g., ingredients database 255 of FIG. 3B) through ingredients API 455. In yet another example, coupon information 448 may be communicated with an external database (e.g., coupons database 245 of FIG. 3B) through coupons API 445. In another example, health/fitness information 446 may be communicated with an external database (e.g., health/fitness database 235 of FIG. 3B) through health/fitness API 435.

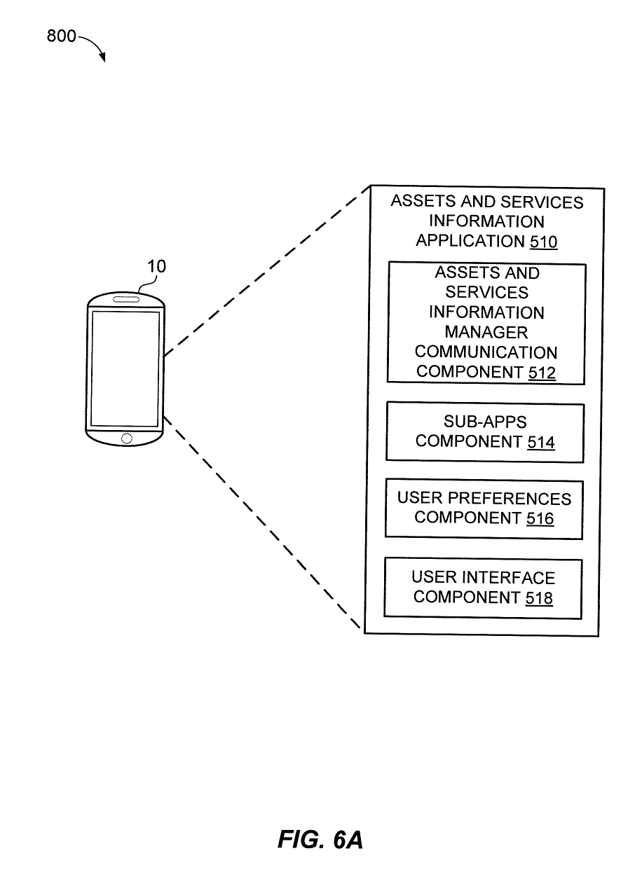

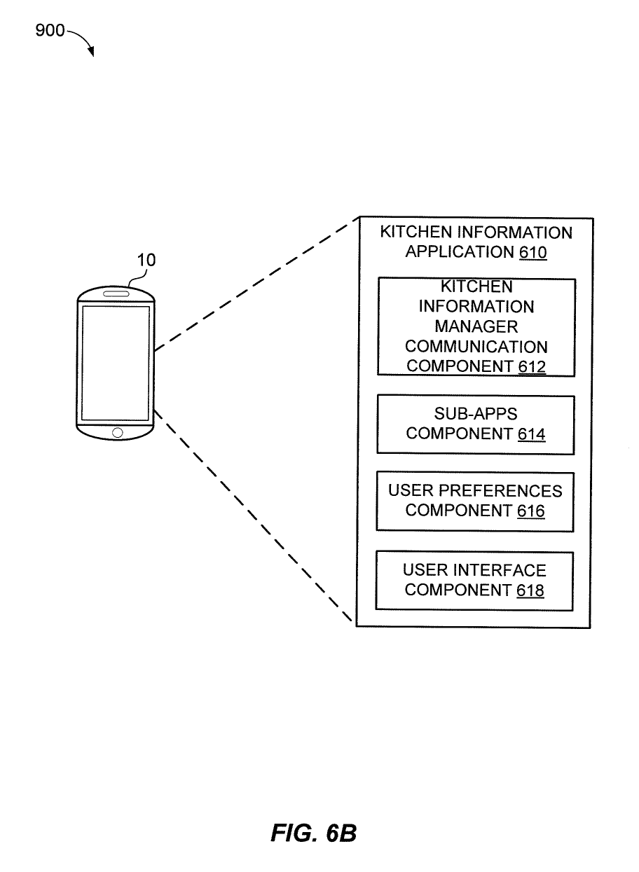

FIG. 6A is a block diagram 800 conceptually illustrating an assets and services information application 510 in accordance with the disclosure. The assets and services information application 510 may be performed or executed on the wireless device 10 (FIG. 1A) in connection with the operation of a smart home information management system. The application 510 may include an assets and services information manager communication component 512, a sub-applications (sub-apps) component 514, a user preferences component 516, and a user interface 518.

The assets and services information manager communication component 512 may be configured to collect and/or input information (e.g., inventory information) and to communicate information (e.g., inventory information, services information) between the wireless device 10 and the assets and services information manager 110 (FIG. 3A) and between the wireless device 10 and one or more of the devices 32, 34, 36, 38, and 40. The sub-apps component 514 may be configured to provide particular features, services, functions associated with users of the smart home information management system. The user preferences component 516 may be configured to provide, configure, update user preferences for one or more users of the smart home information management system. The user interface component 518 may be configured to enable a user to input information and receive or use information (e.g., information being displayed).

FIG. 6B is a block diagram 900 conceptually illustrating a kitchen information application in accordance with the disclosure. The kitchen information application 610 may be performed or executed on the wireless device 10 (FIG. 1B) in connection with the operation of a smart kitchen information management system. The application 610 may include kitchen information manager communication component 612, a sub-apps component 614, a user preferences component 616, and a user interface 618.

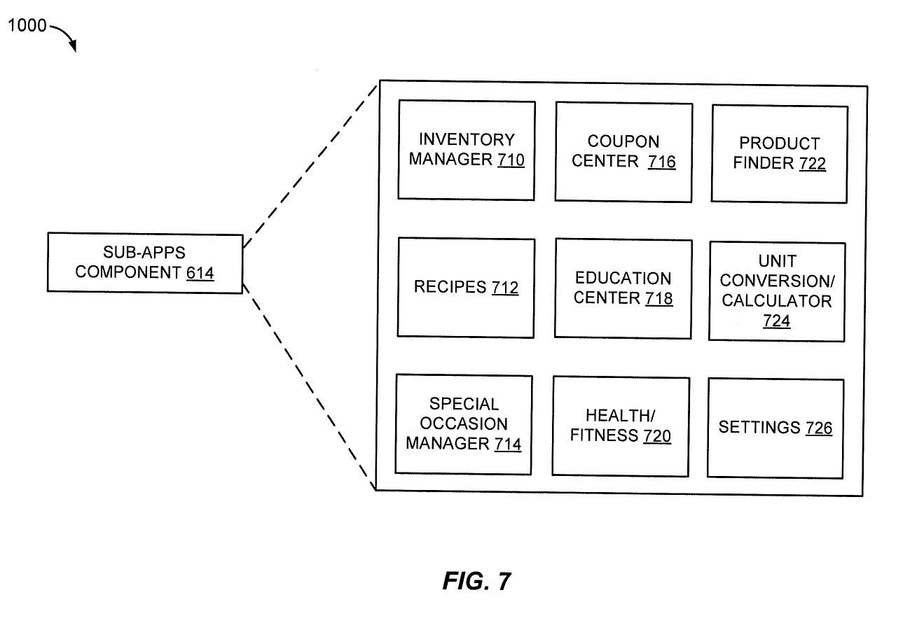

The kitchen information manager communication component 612 may be configured to collect and/or input information (e.g., kitchen inventory information) and to communicate information (e.g., kitchen inventory information, kitchen-related services information) between the wireless device 10 and the kitchen information manager 210 (FIG. 3B) and between the wireless device 10 and one or more of the kitchen devices 60, 70, 80, and 90. The sub-apps component 614 may be configured to provide particular features, services, functions associated with users of the smart kitchen information management system (see FIG. 7). The user preferences component 616 may be configured to provide, configure, update user preferences for one or more users of the smart kitchen information management system. The user interface component 618 may be configured to enable a user to input information and receive or use information (e.g., information being displayed).

FIG. 7 is a block diagram 1000 conceptually illustrating a set of the sub-apps 614 for the information manager communication component 612 of FIG. 6B in accordance with the disclosure. The sub-apps 614 may include applications that may be executed in connection with the information or data used by the smart kitchen information management system such as the information described above with respect to FIG. 5, for example.

The sub-apps 614 may include applications for inventory manager 710, recipes 712, special occasion manager 714, coupon center 716, education center 718, health/fitness 720, product finder 722, unit conversion/calculator 724, and settings 726.

The inventory manager application 710 may be configured to input information such as to input a list of products or items, or information about those products or items, into the system (e.g., smart kitchen information management system). The information may be introduced directly from a merchant (e.g., on-line delivery services), through a smartphone, tablet, or smart appliance (e.g., wireless device 10, smart refrigerator), through add-on devices, manually, or through other devices (e.g., Wi-Fi scale).

The inventory manager application 710 may be configured to output information such as indications of current levels or quantities of a product or item. The change in levels or quantities may be obtained through a reader or add-on device, through a Wi-Fi food scale, or manually, for example.

The inventory manager application 710 may be configured to keep track of storage of food or kitchen items in, for example, a refrigerator, a freezer, a pantry, a basement, an attic, and/or in any other device, location, or appliance. The inventory manager 710 may be configured to keep track of product/food expiration dates to keep control of these items and create alerts when the expiration date is reached. The inventory manager 710 may be configured to use different types of expiration ranges for the products/foods being tracked. For example, there may be a very short expiration (less than a week), a short expiration (one week), a medium expiration (between one and three weeks), a long expiration (more than one month), and a very long expiration (more than six months).

The inventory manager application 710 may be configured to maintain, update, and/or otherwise handle user profile information such as alerts, regularity of purchases, budgets (e.g., weekly, monthly, or user-defined budgets), whether a user prefers some purchases to take place in a grocery store while others can take place on-line, and/or whether a user has preferences regarding retail and wholesale purchases.

The inventory manager application 710 may be configured to analyze, process, and/or otherwise handle the generation of smart lists (e.g., grocery lists), when to place an order, and/or purchasing and consumption behavior.

The inventory manager application 710 may be configured to analyze, process, and/or otherwise handle product-related behavior such as whether consumption of a product is for a specified period of time, what quantities of a particular product are purchased/consumed, and/or the optimization of purchases in terms of prices, offers, budget, and consumption.

For each of the products or items available through the inventory manager application 710, a box or other display structure may be provided to include one or more of a photograph or drawing representative of the product, nutritional facts, related news articles, calories highlights, link to a product finder (e.g., link provided through product finder application 722), access to substitutes information, other related information about the product, purchasing behavior related to the products, expiration dates, links to manufacturer and/or retailer, recommendations of use of the product based on expiration dates and use.

The recipes application 712 may be configured to perform various functions related to requesting and/or obtaining recipes. For example, the recipes application 712 may be configured to interact with a recipes database (e.g., Epicure). The recipes application 712 may enable input such as manual input, inputs from websites, copy-and-paste inputs, electronic messages, and pictures. Moreover, the information may be shared with others outside the smart kitchen information management system.

The recipes application 712 may be configured to be intuitive and be able to recognize quantities, units, products, preparation, and utensils (tools) used for certain recipes. The recipes application 712 may be configured to find related terms and offer substitutes. The recipes application 712 may be able to store substitute's information for future reference. The recipes application 712 may be configured to recommend utensils (tools) that may be needed, where to find them or purchase them (and their price).

The recipes application 712 may be configured to obtain smart recipes, that is, recipes that are based on ingredients available in the current inventory, with suggestions for any missing ingredients. The recipes application 712 may also be configured to produce a cost estimate of preparing a certain recipe and to provide suggestions to reduce the number of calories based on substitute ingredients (e.g., Smart Calories®).

The recipes application 712 may be configured for social collaboration such as having followers for recipes published by the user, to follow others that have posted recipes, provide feedback on certain recipes and/or people posting recipes, suggest changes to the recipes, and obtain coupons or other incentives to publish or post recipes and to interact with others.

The special occasion manager application 714 may be configured to perform various functions related to preparing food for special occasions. The special occasion manager application 714 may be configured to find solutions or options to prepare a special event (e.g., anniversary dinner), to obtain recipes based on food category (e.g., BBQ, Mexican food, Chinese food, Japanese food), to determine the solutions or options based on the number of people and/or according to an established budget. The special occasion manager application 714 may be configured to enable the use of catering businesses.

The special occasion manager application 714 may be configured to offer recipes for a particular event, identify the cost of preparing the recipes based on inventory, needed ingredients, and number of people, identify utensils or other tools needed to prepare and serve the food, offers places to purchase the utensils or tools, suggests decorations for the special event, suggests a playlist for the category of the special event, prepares a checklist of all aspects needed to complete preparation of the special event, provides a platform for online purchases and deliveries, provides a platform to search for discounts or coupons (e.g., through the coupon center application 716).

The special occasion manager application 714 may be configured to create a site for placing photographs of the event and to list previous events, comments, and reviews of those events.

The unit conversion/calculator application 724 may be configured as a standalone sub-application that can interact with the other sub-applications and that may be used to convert or calculate cooking information related to weight, volume, size, temperature, time, and energy or power.

The operation of unit conversion/calculator application 724 may include the ability to provide instructions (e.g., audio, video) for the user to learn how to use unit conversion for different tasks. The unit conversion/calculator application 724 may be accessible from any other application in the sub-apps component 614. The unit conversion/calculator application 724 may also operate in the background such that when units displayed in other applications, a conversion to other units may be shown automatically without having to leave the other applications. The unit conversion/calculator application 724 may be configured to change the units in items in a recipe to a different set of units (e.g., from British or American units to metric system).

The education center application 718 may be configured to perform various functions related to different types of advice, including video, documentaries, subscriptions to information from people or businesses (e.g., blogs), whether paid or unpaid. The advice provided through the education center 718 may be based on the user's needs and/or the type of product being considered.

In general, the education center application 718 may be configured to provide the user with news, written articles, or other information related to health, nutrition, and/or products. The information provided by the education center application 718 may be from specialists, affiliated magazines, blogs, or other digital media sources such as the internet, and/or postings from other users in the same group or in different groups. The education center application 718 may be configured to allow the users to provide reviews, commentaries, observations, and share with other users questions and/or opinions regarding a certain product or article.

The education center application 718 may be accessible from any other application in the sub-apps component 614 as a user may select a product (e.g., user may click on an image or other indication of a product displayed in wireless device 10) and the system may search for new or articles about the product and provide a summary of the results for the user to browse at his or her convenience.

The health/fitness application 720 may be configured to perform various functions related to health and fitness choices. For example, the health/fitness application 720 may be able to determine, based on purchases and inventory, a degree of health of the items in a refrigerator, freezer, and/or pantry. The health/fitness application 720 may make recommendations of food substitutes based on a goal or objective (e.g., reduces weight, have more healthy diet). The health/fitness application 720 may be used to keep track of exercise activities and diet. The health/fitness application 720 may be used to access diet/nutritional subscriptions (e.g., Jenny Craig®, Weight Watchers®). The health/fitness application 720 may be used with customized nutritional services and may even be able to connect the user with certain sponsored nutritionists, which may receive information about the user (e.g., may access inventory information) to suggest changes in diet and to develop nutrition objectives.

The operation of the health/fitness application 720 enables a user to maintain a record of his or her activities, including sporting activities. Such services may be offered by third-party service providers affiliated with the smart kitchen inventory management system. Examples of commercial entities that provide such services include Garmin, Polar, and the like.

The operation of the health/fitness application 720 enables a user to have access to tools and applications that improve the user's health and nutrition. Nutritional add-on services, whether general or personalized, may be provided to the user through the system. These services, which may be provided by local, regional, or global commercial entities, may utilize the eating habits of the user captured by the system through, for example, food inventory management and monitoring, as well as records of the daily activities performed by the user. For example, smart or sport watches, heart rate monitors, and other similar devices may be used to provide information about a user's activities and performance. These services may enable nutritionists to work with the user to implement and monitor dieting programs, and be able to adjust or modify the program regularly based on feedback provided through the system. As part of the services, nutritionists may offer recipes, which the user may evaluate and/or user in connection with the recipes application 712. Users may be enabled, through the health/fitness application 720, to provide reviews and commentaries of the services offered by the third-party service providers.

The coupon center application 716 may be configured to perform various functions related to obtaining and/or receiving coupons. For example, the coupon center application 716 may enable interaction with coupon providers such as coupons.com, for example. Such providers may be used to have targeted coupons based on shopping behavior and to provide different coupons suggestions. The coupon center application 716 may enable getting coupons from manufacturers, merchants, and local/nationwide/online coupons. The coupon center 716 may be configured to organize coupons according to product type and to provide other types of user incentives. The coupon center application 716 may be configured to provide points, group coupons, popular coupons, and coupons based on people or recipes followed by the user. The coupon center application 716 may be configured to offer coupons on certain dates based on the merchant. The user may optimize shopping based on the coupons being offered and the inventory of things that need to be bought (e.g., Grocery IQ).

The operation of the coupon center application 716 may be based, at least in part, on user behavior, including location of the user, user's consumption (e.g., amount and frequency of consumption of a particular product, item, or article), offers or suggestions for products, and recipes. Based on such information, a smart kitchen information management system may be used by affiliated manufacturers or commercial entities to provide coupons, volume coupons, special offers, targeted advertisement to users through, for example, the coupon center application 716. Related services may also include scheduling offers for the purchase of kitchen tools and/or food items that the user may need based on the user's behavior and/or upcoming events.

The product finder application 722 may be configured to analyze, process, and/or otherwise handle various aspects of finding or identifying product information. For example, the product finder application 722 may perform functions associated with related businesses, substitute products (e.g., based on whether Kosher, organic, diet), price comparisons, sponsored products and related links, product search (e.g., manual search, barcode search), search inventory (e.g., identify if the items are available, available quantities, price paid, where it is located).

The operation of the product finder application 722 is configured to allow flexibility in the way in which a user finds or searches for a product. For example, the product finder application 722 may be configured to enable a user to find or search for a product based on the product's bar code (e.g., through scanning or inputting the bar code's numbers), the name or brand associated with the product, or by providing a product that the smart kitchen information management system can use to identify a list of similar or substitute products. Based on these searching capabilities, the product finder application 722 may be configured to produce different search results. For example, the product finder application 722 may provide, for display or otherwise, a description of the product (e.g., a description provided by the manufacturer), multiple similar or substitute products, where the product is available for purchasing (e.g., stores, on-line suppliers), comparative list of prices of the product at different places, coupons or other offers currently available for the product, and/or services for the purchase and/or delivery of the product. Through the product finder application 722, a user may obtain the product and may even be able to update the inventory of household items. The smart kitchen information management system may keep track of which products are searched for, the frequency of the searches, and/or which products are purchased by the user to analyze this information and offer suggestions, coupons, and/or discounts to the user. If a product is not found as a result of the search, and if similar products are not available from a search database, the system may flag this product such that information about the product and/or similar products is added to the search database for future searches.

The settings application 726 may be configured to allow a user to set up preferences and/or other settings associated with one or more of the sub-apps in the sub-apps component 614.

The various operations and/or functions supported by the smart home information management system and the smart kitchen information management system described herein may enable the implementation of targeted advertising, including advertising from manufacturers, supermarkets, hardware stores, services (e.g., catering, home delivery, nutritionists), local distributors, and online retailers and online deliveries. It may be possible to establish various revenue sharing opportunities as a result that may not be possible without the smart home information management system and the smart kitchen information management system. Moreover, it may be possible to implement premium services to different users and subscription-based services. It may also be possible to add to the smart home information management system and the smart kitchen information management system various add-on appliances or devices. In addition, new applications (apps) may be develop to use with the smart home information management system and the smart kitchen information management system.

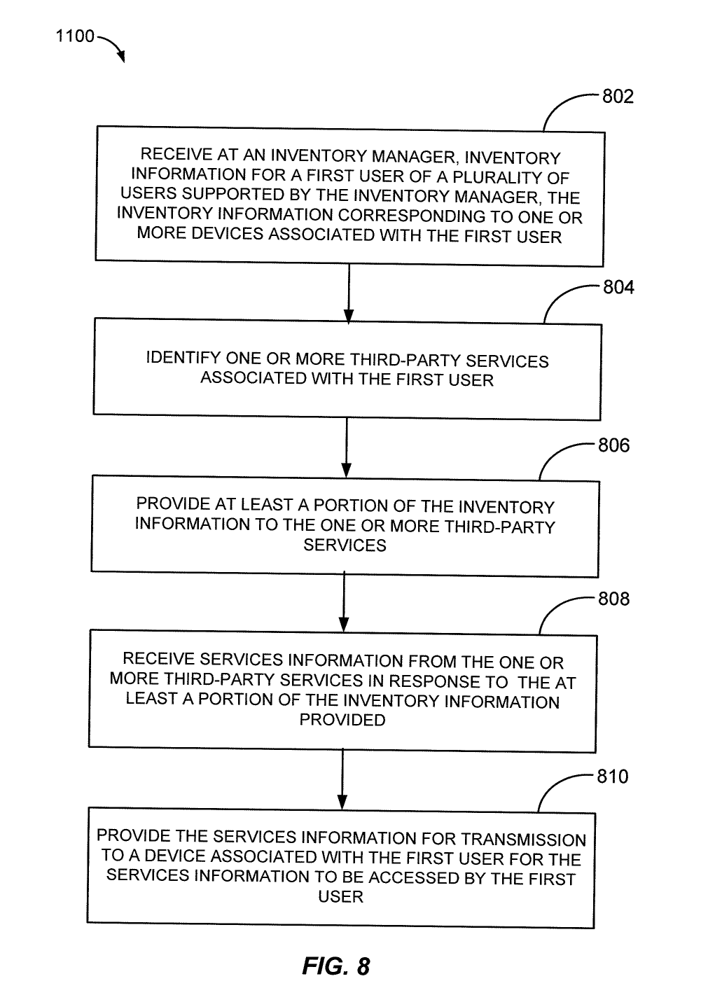

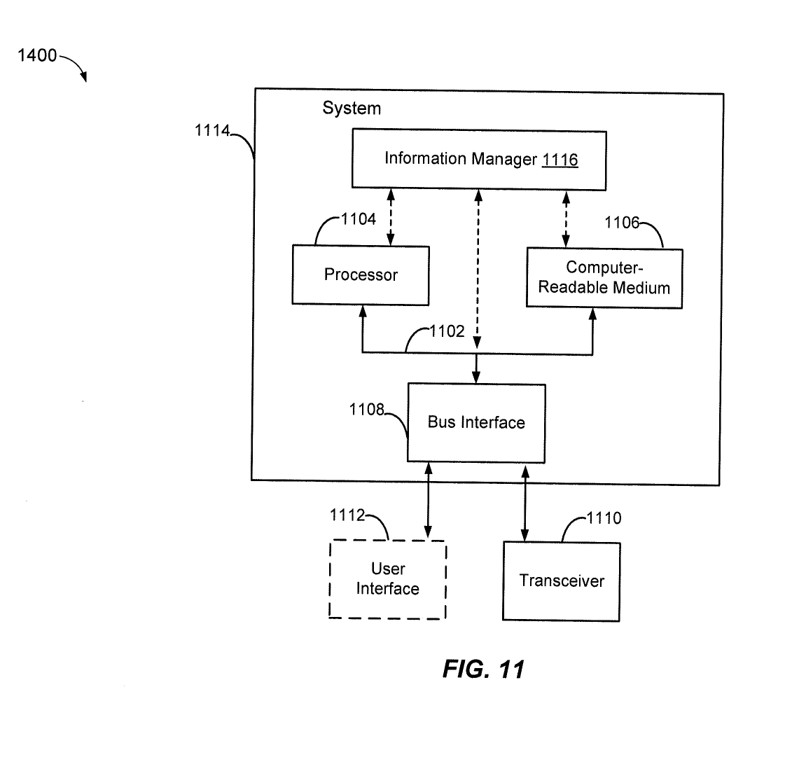

FIG. 8 is a flow diagram conceptually illustrating a method 1100 for home information management in accordance with the disclosure. It should be understood that any one or more of the various component and/or subcomponents of the assets and services information manager 110 (FIGS. 3A and 4A) or various component and/or subcomponents associated with the processing system 1114 (FIG. 11) may be executed to perform the aspects described herein with respect to each block forming method 1100. For example, one or more of the processing component 114 and the DB accessing component 116 of the assets and services information manager 110 may be used to perform one or more of blocks 802, 804, 806, 808, and 810 described below. In another example, one or more of the information manager 116, the processor 1104, and the computer-readable medium 1106 may be used to perform one or more of blocks 802, 804, 806, 808, and 810 described below.

In an aspect, at block 802, the method 1100 may include receiving at an inventory manager (e.g., assets and services information manager 110), inventory information for a first user of multiple users supported by the inventory manager, the inventory information corresponding to one or more devices (e.g., devices 32, 34, 36, 38, and 40 of FIG. 1A) associated with the first user.

At block 804, the method 1100 may include identifying one or more third-party services (e.g., consumer services server 120, databases 125, 135, 145, and 155) associated with the first user.

At block 806, the method 1100 may include providing at least a portion of the inventory information to the one or more third-party services.

At block 808, the method 1100 may include receiving services information from the one or more third-party services in response to the at least a portion of the inventory information provided.

At block 810, the method 1100 may include providing the services information for transmission to a device (e.g., wireless device 10) associated with the first user for the services information to be accessed by the first user. The services information may specify, for the first user, information about one or more products, one or more services, or both, in connection with the one or more third-party services.

In another aspect of the method 1100, the one or more devices associated with the first user comprise one or both of an appliance configured to identify content stored or handled within the appliance and an electronic device configured to identify content stored or handled within the electronic device. The content stored or handled within the appliance or the electronic device includes one or more items consumed or used by the first user.

In another aspect of the method 1100, the method may further include generating statistical information from the information received for the first user and from information received from one or more other users from the plurality of users, and providing at least a portion of the statistical information to the one or more third-party services, wherein receiving services information includes receiving services information from the one or more third-party services in response to the at least a portion of the statistical information provided.

In another aspect of the method 1100, the method may further include receiving a request from the first user in response to the services information provided, wherein the request indicates one or both of a particular product and a particular service desired by the first user.

In another aspect of the method 1100, the device associated with the first user is a mobile terminal (e.g., wireless device 10) configured to execute one or more inventory applications. Moreover, providing services information includes identifying which of the one or more inventory applications is associated with the services information, and configuring the services information to be accessed by the first user via the identified inventory application. The one or more inventory applications includes one or more of a home inventory application, office inventory application, room inventory application, and building storage information.

In another aspect of the method 110, the method may further include configuring an application programming interface (API) for each of the one or more one or more third-party services associated with the first user, wherein receiving services information comprises receiving services information from the one or more third-party services via the respective API.

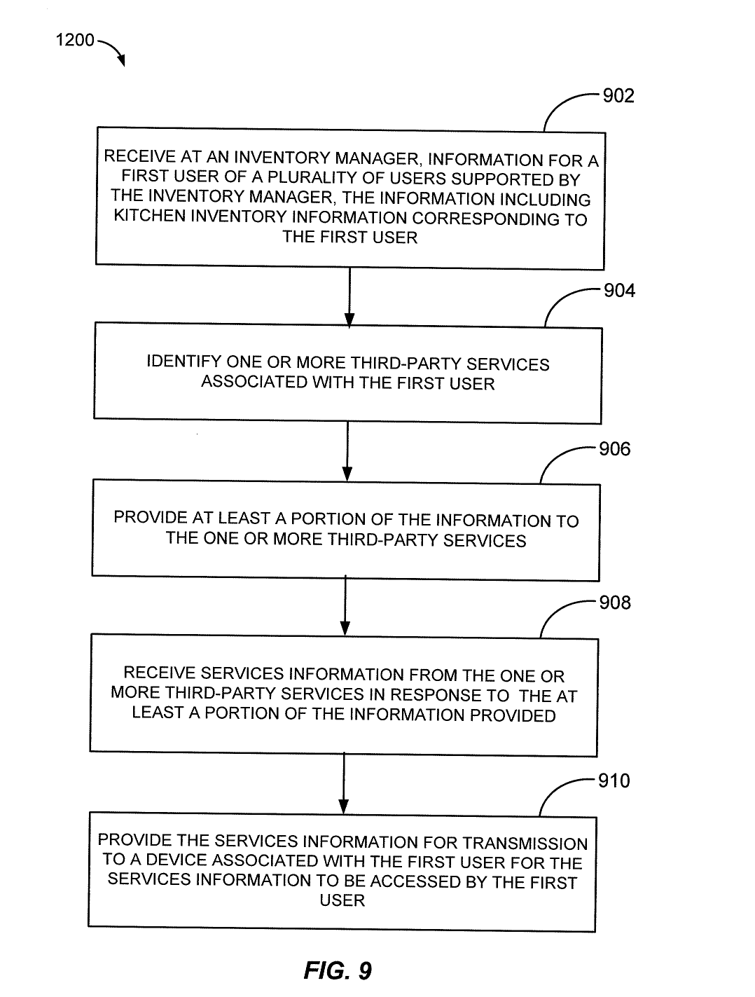

FIG. 9 is a flow diagram conceptually illustrating a method 1200 for kitchen information management in accordance with the disclosure. It should be understood that any one or more of the various component and/or subcomponents of the kitchen information manager 210 (FIGS. 3B and 4B) or various component and/or subcomponents associated with the processing system 1114 (FIG. 11) may be executed to perform the aspects described herein with respect to each block forming method 1200. For example, one or more of the processing component 214 and the DB accessing component 216 of the kitchen information manager 110 may be used to perform one or more of blocks 902, 904, 906, 908, and 910 described below. In another example, one or more of the information manager 116, the processor 1104, and the computer-readable medium 1106 may be used to perform one or more of blocks 802, 804, 806, 808, and 810 described below.

In an aspect, at block 902, the method 1200 may include receiving at an inventory manager (e.g., kitchen information manager 210), information for a first user of multiple users supported by the inventory manager, the information including kitchen inventory information corresponding to the first user.

At block 904, the method 1200 may include identifying one or more third-party services (e.g., consumer services server 220, databases 225, 235, 245, and 255) associated with the first user.

At block 906, the method 1200 may include providing at least a portion of the information to the one or more third-party services.

At block 908, the method 1200 may include receiving services information from the one or more third-party services in response to the at least a portion of the information provided.

At block 910, the method 1200 may include providing the services information for transmission to a device (e.g., wireless device 10) associated with the first user for the services information to be accessed by the first user. The services information specify for the first user information about one or more products, one or more services, or both, in connection with the one or more third-party services

In another aspect of the method 1200, receiving services information from the one or more third-party services includes receiving one or more of recipes information, coupons, product information, health information, and fitness information identified based at least in part on the kitchen inventory information.

In another aspect of the method 1200, the method may further include generating statistical information from the information received for the first user and from information received from one or more other users from the plurality of users, and providing at least a portion of the statistical information to the one or more third-party services, wherein receiving services information includes receiving services information from the one or more third-party services in response to the at least a portion of the statistical information provided.

In another aspect of the method 1200, the method may further include receiving a request from the first user in response to the services information provided, wherein the request indicates one or both of a particular product and a particular service desired by the first user.

In another aspect of the method 1200, the device associated with the first user is a mobile terminal (e.g., wireless device 10) configured to execute one or more kitchen inventory applications. Moreover, providing services information includes identifying which of the one or more kitchen inventory applications is associated with the services information and configuring the services information to be accessed by the first user via the identified kitchen inventory application.

In another aspect of the method 1200, the method further includes configuring an application programming interface (API) for each of the one or more one or more third-party services associated with the first user, wherein receiving services information includes receiving services information from the one or more third-party services via the respective API.

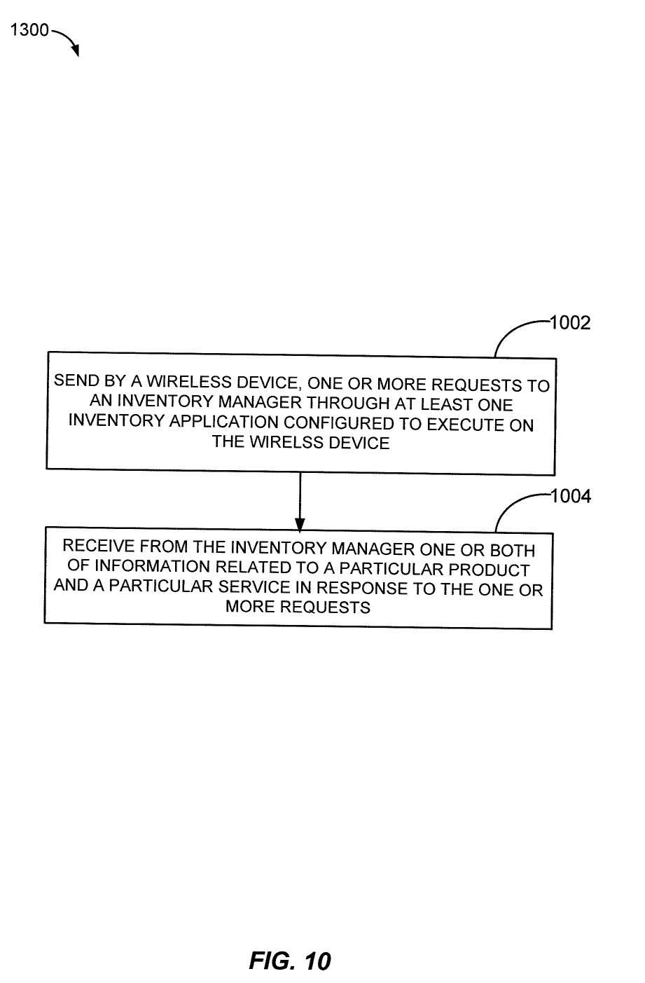

FIG. 10 is a flow diagram conceptually illustrating a method 1300 for interacting with an inventory manager (e.g., assets and services information manager 110, kitchen information manager 210) in accordance with the disclosure. It should be understood that any one or more of the various component and/or subcomponents of the wireless device 10, the assets and services information application 510, and/or the kitchen information application 610 (FIGS. 1A, 6A, and 6B) may be executed to perform the aspects described herein with respect to each block forming method 1300. In another example, one or more of components and/or subcomponents of the processing system 114 may be executed to perform the aspects described herein with respect to each block forming method 1300.

In an aspect, at block 1002, the method 1300 may include sending by a wireless device (e.g., wireless device 10), one or more requests to an inventory manager (e.g., assets and services information manager 110, kitchen information manager 210) through at least one inventory application (e.g., assets and services information application 510, kitchen information application 610) configured to execute on the wireless device.

At block 1004, the method 1300 may include receiving from the inventory manager one or both of information related to a particular product and a particular service in response to the one or more requests.

In another aspect of the method 1300, the services information includes one or more of recipes information, kitchen information, product information, health information, and fitness information identified based at least in part on inventory information obtained by the inventory manager and associated with the first user.

In another aspect of the method 1300, the method may further include receiving an input identifying inventory information associated with the first user, and providing the inventory information for transmission to the inventory manager for storage in one or more databases accessible by the inventory manager. The method 1300 may further include generating an indication of which of the one or more third-party services is associated with the inventory information, and providing the indication for transmission to the inventory manager.

In another aspect of the method 1300, the method may further include receiving from the inventory manager an advertisement for display on the mobile terminal, wherein the advertisement is associated with the one or more requests and inventory information accessed by the inventory manager and associated with the first user.

In another aspect of the method 1300, the one or more products and the one or more services are associated with physical assets consumed or used by the first user in a specified area (e.g., room, home, building), and the services information is based at least in part on inventory information obtained by the inventory manager from one or both of appliances and electronic devices located in or near the specified area and associated with the user.

FIG. 11 is a block diagram conceptually illustrating an apparatus 1400 for home and/or kitchen information management in accordance with the disclosure. The apparatus 1400 may employ a (processing) system 1114 configured with an information manager 1116 for performing the actions described herein. The system 1114 and/or the information manager 1116 may correspond to the assets and services information manager 110 or the kitchen information manager 210. In this example, the system 1114 may be implemented with a bus architecture, represented generally by the bus 1102. The bus 1102 may include any number of interconnecting buses and bridges depending on the specific application of the system 1114 and the overall design constraints. The bus 1102 links together various circuits including one or more processors, represented generally by the processor 1104, and computer-readable media, represented generally by the computer-readable medium 1106. A bus interface 1108 provides an interface between the bus 1102 and a transceiver 1110. The transceiver 1110 provides a means for communicating with various other apparatus over a transmission medium. Depending upon the nature of the apparatus 1400, a user interface 1112 (e.g., keypad, display, speaker, microphone, joystick) may also be provided.

The processor 1104 is responsible for managing the bus 1102 and general processing, including the execution of software stored on the computer-readable medium 1106. The software, when executed by the processor 1104, causes the system 1114 to perform the various functions described infra for any particular apparatus. The computer-readable medium 1106 may also be used for storing data that is manipulated by the processor 1104 when executing software. The information manager 1116 may be a part of processor 104 and/or computer-readable medium 106.

As described above with respect to the smart home information management system and the smart kitchen information management system associated with FIGS. 1A, 1B, 3A, and 3B, a user may receive recommendations, coupons, and/or offers for different products and/or services through a device such as the wireless device 10, for example. The user experience related to these activities may be defined or determined in connection with graphical user interface (GUI) screens and/or applications (e.g., mobile or web) with which the user can interact. For example, applications and/or GUIs executing in the wireless device 10 may be used in connection with recommendations, coupons, and/or offers, including display, scanning, input, output, transfer, and other operations.

A recommendation provided by the smart home information management system or the smart kitchen information management system may be of two types: (1) a product and/or service that the user may be interested in; and (2) a class of products and/or services that the user may be interested in. For the first type, examples may include a specific food item or a specific supermarket. For the second type, examples may include “vegetables with Vitamin A” or “foods with high fiber content.”

The smart home information management system (e.g., through the assets and services information manager 110 or the system 1114/information manager 1116), or the smart kitchen information management system (e.g., through the kitchen information manager 210 or the system 1114/information manager 1116), may be configured to determine recommendations, as well as proposals, advice, and the like for different products and/or services, by implementing and performing a series of rules. The specification of these rules may have two components: (1) a targeting function; and (2) a recommendation. The targeting function or heuristic is an abstract representation of data that takes a consumer or user data (i.e., consumer consumption data) as input and returns a numerical result as output. The numerical result may have, for example, a fractional value between 0 and 1. A targeting function is to typically return a higher numerical output (e.g., closer to 1) when the consumer consumption data indicates that the consumer or user may be interested in a particular recommendation (a similar approach may occur for coupons or offers). In one example of rule specification, a targeting function may be implemented and operated in an information manager such that it returns a numerical result of 1 when the consumer has purchased a butter product with high saturated fat content, and a numerical result of 0 otherwise. In such an example, a recommendation may be a specific butter-substitute product with similar taste and characteristics but with lower or no saturated fat content. In another example of rule specification, a targeting function may be implemented and operated in an information manager such that it returns a numerical result that is inversely proportional to the amount of fiber content in the products that the consumer or user has purchased (e.g., closer to 1 for low fiber content and closer to 0 for high fiber content). In such an example, a recommendation may be a class of “vegetables with high fiber content”. A recommendation need not identify a single item, product, or service, but may provide a list of items, products, or services.

The numerical result assigned by the specified rule may be based on the objective of the rule. For example, a rule may be intended to provide healthier substitutes, lower cost substitutes, complimentary products/services, and/or a combination of these. Accordingly, the numerical result achieve by the targeting function will vary based on the objective of the specified rule.

In the description above, a consumer or user may be a person or individual who submits, or who consents to the automated submission of, information into a smart home or kitchen information management system about his/her past and/or present consumption of products or services. The consumer may also access an application and/or GUI (e.g., user experience) to view recommendations of products and/or services. The consumer may access an application and/or GUI to view and/or analyze information about their consumption patterns through different types of visualization tools that may be available. In this regard, the smart home or kitchen information management system may be configured to process, organize, and provide consumption patterns information obtained from inventory information captured by the system.

In the description above, a provider may be an entity or company that submits rule specifications to the system about products and/or services that the provided wishes to make available, sell, or offer to the consumers or users that match a targeting function.

In order to provide recommendations (as well as to suggest coupons and other offers), inputs to the system may be consumption data (e.g., information about a consumer or user's past and/or present consumption of products and/or services) and rule specifications provided by one or more third-party providers. The consumption data may be obtained by the system from, for example, inventory changes that are tracked by the system, by direct input of consumption behavior by the consumer or user, or by a combination of both.

Actions associated with recommendations provided by the smart home information management system or the smart kitchen information management system may include: (1) submission (or otherwise identification) of consumer consumption data into the system; (2) submission to the system (generally by a provider) of a product and/or service specification rule or rules; and (3) visit or access of applications and/or GUIs (e.g., user experience) to view recommendations and/or consumption patterns.

The system (e.g., assets and services information manager 110, kitchen information manager 210, or system 1114/information manager 116) may be configured to implement and operate a data model for recommendations. The data model described herein for recommendations may be similarly used when recommending or providing recipes, coupons, offers, ingredients, products, shopping lists, health/fitness suggestions, utensils, and special occasions, to name a few. The data model may include a different types of data that when processed by at least a processor (e.g., processor 1104) in the system enables the generation of recommendations. The system may therefore maintain the following information as part of the data model: (1) consumption data; (2) product/service properties; (3) rule specifications; and (4) persisted recommendation list. The consumption data (or consumer consumption data) may include a collection of tuples consisting of a product identifier, an event identifier, a date/time (e.g., timestamp) of when the event took place. Examples of events may be a transaction at a supermarket, attendance to a gym class, etc. Each product and/or service entered into the system is associated with a collection of properties. Examples of properties can be the amount of a specific nutrient that a food product contains, a category that the product/service belongs to (e.g., sodas, butter, paper products, etc.), a Boolean indicator of whether a food product or food item is organic, a Boolean indicator of whether a food product or food item contains gluten, energy consumption rate of an electro domestic product (e.g., toaster, toaster oven, microwave). The system may also maintain a list of the different rule specifications that have been entered into the system and that are active in the system. The rule specifications may be entered into the system by the entity or company that manages the system and/or by providers that are affiliated with the system and are therefore authorized to enter rule specifications into the system. For each consumer there may be a unique persisted recommendation list that includes the best-matching recommendations for that consumer.

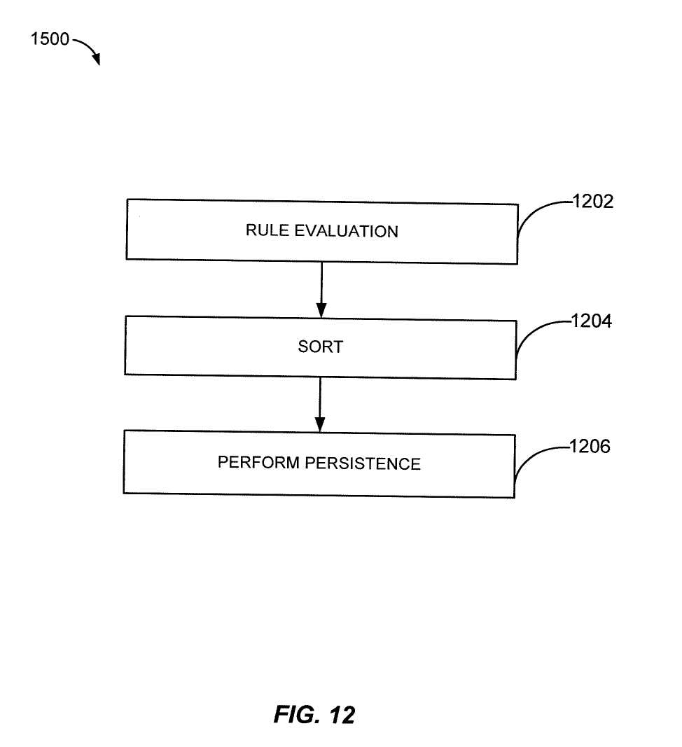

The system (e.g., assets and services information manager 110, kitchen information manager 210, or system 1114/information manager 116) may be configured to implement and operate algorithms associated with the generation of recommendations. An example of an algorithm is described in connection with a method 1500 in FIG. 12. At 1202 of method 1500, a rule evaluation may be performed. The rule evaluation may execute the targeting function of each rule specification for each consumer. Once the rule evaluation is performed, for each consumer there is a list of tuples that have the form (Rule, Numerical Result). At 1204, a sorting operation may be performed. In the sorting, for each consumer, the list generated at 1202 is pre-sorted in decreasing order based on the numerical results for the different rules specified. Then the pre-sorted list is again sorted for best matching such that the highest numerical result produces the best matching recommendation to make to the consumer, the next highest numerical result produces the next best matching recommendation to make to the consumer, and so on. At 1206, a persistence operation is performed. In the persistence operation, for each consumer, persist (to the data model) the top N (where N≦number of rules specified) recommendations from the list, which now consists of the persisted recommendation list for the consumer, along with the numerical results. Once the top recommendations for a particular consumer are available, the recommendations and/or numerical results may be provided for visualization and analysis by that consumer. For example, the application and/or GUI may display to the consumer a visual representation of one or more recommendations after looking up the persisted recommendation list of the given consumer from the data model.

The generation of a recommendation can be initiated offline or on-demand. In offline generation, the system may initiate the generation of a recommendation based on a pre-determined execution schedule. In on-demand generation, a consumer may trigger the generation of a recommendation upon visiting an application and/or GUI that provides the user experience described above.

In another aspect associated with the generation of recommendations, when a consumer is interacting with an application and/or GUI (e.g., user experience) with a visualization that illustrates their recent consumption of certain nutrients, a recommendation for which its targeting function is related to such properties may be presented (e.g., the targeting function, in addition to taking the consumption data as input may also take a screen identifier as input). In such cases, which may be referred to as contextual recommendations, the data model, as well as the lookup and display of recommendation information may include the screen identifier.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for managing information, comprising:
receiving at an inventory manager, inventory information for a first user of a plurality of users supported by the inventory manager, the inventory information corresponding to one or more devices associated with the first user;
identifying one or more third-party services associated with the first user;
providing at least a portion of the inventory information to the one or more third-party services;
receiving services information from the one or more third-party services in response to the at least a portion of the inventory information provided; and
providing the services information for transmission to a device associated with the first user for the services information to be accessed by the first user, wherein the services information specify for the first user information about one or more products, one or more services, or both, in connection with the one or more third-party services.

2. The method of claim 1, wherein the one or more devices associated with the first user comprise one or both of:
an appliance configured to identify content stored or handled within the appliance; and
an electronic device configured to identify content stored or handled within the electronic device.

3. The method of claim 2, wherein the content stored or handled within the appliance or the electronic device includes one or more items consumed or used by the first user.

4. The method of claim 1, further comprising:
generating statistical information from the information received for the first user and from information received from one or more other users from the plurality of users; and
providing at least a portion of the statistical information to the one or more third-party services,
wherein the receiving services information comprises receiving services information from the one or more third-party services in response to the at least a portion of the statistical information provided.

5. The method of claim 1, further comprising receiving a request from the first user in response to the services information provided, wherein the request indicates one or both of a particular product and a particular service desired by the first user.

6. The method of claim 1, wherein:
the device associated with the first user is a mobile terminal configured to execute one or more inventory applications, and
the providing services information comprises:
identifying which of the one or more inventory applications is associated with the services information; and
configuring the services information to be accessed by the first user via the identified inventory application.

7. The method of claim 6, wherein the one or more inventory applications includes one or more of a home inventory application, office inventory application, room inventory application, and building storage information.

8. The method of claim 1, further comprising configuring an application programming interface (API) for each of the one or more one or more third-party services associated with the first user,
wherein receiving services information comprises receiving services information from the one or more third-party services via the respective API.

9. An apparatus for managing information, comprising:
means for receiving at an inventory manager, inventory information for a first user of a plurality of users supported by the inventory manager, the inventory information corresponding to one or more devices associated with the first user;
means for identifying one or more third-party services associated with the first user;
means for providing at least a portion of the inventory information to the one or more third-party services;
means for receiving services information from the one or more third-party services in response to the at least a portion of the inventory information provided; and
means for providing the services information for transmission to a device associated with the first user for the services information to be accessed by the first user, wherein the services information specify for the first user information about one or more products, one or more services, or both, in connection with the one or more third-party services.

10. A non-transitory computer-readable medium including:
instructions for causing a computer to receive at an inventory manager, inventory information for a first user of a plurality of users supported by the inventory manager, the inventory information corresponding to one or more devices associated with the first user;
instructions for causing a computer to identify one or more third-party services associated with the first user;
instructions for causing a computer to provide at least a portion of the inventory information to the one or more third-party services;
instructions for causing a computer to receive services information from the one or more third-party services in response to the at least a portion of the inventory information provided; and
instructions for causing a computer to provide the services information for transmission to a device associated with the first user for the services information to be accessed by the first user, wherein the services information specify for the first user information about one or more products, one or more services, or both, in connection with the one or more third-party services.

11. A method for managing information, comprising:
sending, by a mobile terminal, one or more requests to an inventory manager through at least one inventory application configured to execute on the mobile terminal, wherein each of the one or more requests are in response to services information received from one or more third-party services associated with a first user of the mobile terminal, wherein the services information specify for the first user information about one or more products, one or more services, or both, in connection with the one or more third-party services, and wherein the first user is one of a plurality of users supported by the inventory manager; and
receiving from the inventory manager one or both of a particular product and a particular service in response to the one or more requests.

12. The method of claim 11, wherein the services information comprises recipes information identified based at least in part on inventory information obtained by the inventory manager and associated with the first user.

13. The method of claim 11, wherein the services information comprises coupons identified based at least in part on kitchen information obtained by the inventory manager and associated with the first user.

14. The method of claim 11, wherein the services information comprises product information identified based at least in part on inventory information obtained by the inventory manager and associated with the first user.

15. The method of claim 11, wherein the services information comprises health information identified based at least in part on inventory information obtained by the inventory manager and associated with the first user.

16. The method of claim 11, wherein the services information comprises fitness information identified based at least in part on inventory information obtained by the inventory manager and associated with the first user.

17. The method of claim 11, further comprising:
receiving an input identifying inventory information associated with the first user; and
providing the inventory information for transmission to the inventory manager for storage in one or more databases accessible by the inventory manager.

18. The method of claim 17, further comprising:
generating an indication of which of the one or more third-party services is associated with the inventory information; and
providing the indication for transmission to the inventory manager.

19. The method of claim 11, further comprising receiving from the inventory manager an advertisement for display on the mobile terminal, wherein the advertisement is associated with the one or more requests and inventory information accessed by the inventory manager and associated with the first user.

20. The method of claim 11, wherein:
the one or more products and the one or more services are associated with physical assets consumed or used by the first user in a specified area, and
the services information is based at least in part on inventory information obtained by the inventory manager from one or both of appliances and electronic devices located in or near the specified area and associated with the first user.
